(19) United States
(12) Patent Application Publication
(10) Pub. No.: US 2024/0111830 A1
(43) Pub. Date: Apr. 4, 2024

(54) ACCURACY-BASED APPROXIMATION OF ACTIVATION FUNCTIONS WITH PROGRAMMABLE LOOK-UP TABLE HAVING AREA BUDGET

(71) Applicant: Intel Corporation, Santa Clara, CA (US)

(72) Inventors: Umer Iftikhar Cheema, Hillsboro, OR (US); Robert Simofi, Dumbravita, Timis (RO); Deepak Abraham Mathaikutty, Chandler, AZ (US); Arnab Raha, San Jose, CA (US); Dinakar Kondru, Frisco, TX (US)

(73) Assignee: Intel Corporation, Santa Clara, CA (US)

(21) Appl. No.: 18/534,035

(22) Filed: Dec. 8, 2023

(51) Int. Cl. G06F 17/17; G06F 1/03

(52) U.S. Cl. CPC G06F 17/17; G06F 1/0307

(57) ABSTRACT

A non-linear activation function in a neural network may be approximated by one or more linear functions. The input range may be divided into input segments, each of which corresponds to a different exponent in the input range of the activation function and includes input data elements having the exponent. Target accuracies may be assigned to the identified exponents based on a statistics analysis of the input data elements. The target accuracy of an input segment will be used to determine one or more linear functions that approximate the activation function for the input segment. An error of an approximation of the activation function by a linear function for the input segment may be within the target accuracy. The parameters of the linear functions may be stored in a look-up table (LUT). During the execution of the DNN, the LUT may be used to execute the activation function.

### TECHNICAL FIELD

This disclosure relates generally to deep neural networks (DNN), and more specifically, accuracy-based approximation of activation functions in DNNs with programmable look-up table (LUT) having area budget.

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as each inference can require hundreds of millions of MAC (multiply-accumulate) operations as well as a large amount of data to read and write. DNN inference also requires computation of activation functions. Therefore, techniques to improve efficiency of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example DNN, in accordance with various embodiments.

FIG. 2 is a block diagram of a DNN system, in accordance with various embodiments.

FIG. 3 is a block diagram of a DNN module, in accordance with various embodiments.

FIG. 4 is a block diagram of an activation function module, in accordance with various embodiments.

FIG. 5 illustrates a post processing engine (PPE) array including LUTs, in accordance with various embodiments.

FIG. 6 illustrates an example pipeline of approximating activation functions, in accordance with various embodiments.

FIG. 7 illustrates an example non-linear curve and linear curves approximating the non-linear curve, in accordance with various embodiments.

FIG. 8 illustrates an example linear curve, in accordance with various embodiments.

FIG. 9 is a histogram for an activation function, in accordance with various embodiments.

FIG. 10 is a diagram showing different accuracies determined for different exponents in an input range of the activation function in FIG. 9, in accordance with various embodiments.

FIG. 11 illustrates a programmable LUT, in accordance with various embodiments.

FIG. 12 illustrates an example floating-point datatype, in accordance with various embodiments.

FIG. 13 illustrates another example floating-point datatype, in accordance with various embodiments.

FIG. 14 illustrates yet another example floating-point datatype, in accordance with various embodiments.

FIG. 15 illustrates yet another example floating-point datatype, in accordance with various embodiments.

FIG. 16 illustrates compatible datatypes of LUT entries for various output ranges of activation functions, in accordance with various embodiments.

FIG. 17 is a flowchart showing a process of executing a non-linear activation function in a DNN, in accordance with various embodiments.

FIG. 18 is a flowchart showing a method of approximating a non-linear activation function in a DNN, in accordance with various embodiments.

FIG. 19 is a block diagram of an example computing device, in accordance with various embodiments.

### DETAILED DESCRIPTION

### Overview

The last decade has witnessed a rapid rise in AI (artificial intelligence) based data processing, particularly based on DNNs. DNNs are widely used in the domains of computer vision, speech recognition, image, and video processing mainly due to their ability to achieve beyond human-level accuracy. The significant improvements in DNN model size and accuracy coupled with the rapid increase in computing power of execution platforms have led to the adoption of DNN applications even within resource constrained mobile and edge devices that have limited energy availability.

Activation functions are important parts of DNNs. An activation function can decide whether a neuron should or should not be activated by computing the weighted sum activations and adding bias. An important purpose of activation functions is to introduce non-linearity to the output of neurons. Considering the complexity of some of the non-linear activation functions used in many DNNs, hardware implementation may require approximation within certain level of accuracy. Piece-wise linear approximation is one approach to approximate complex non-linear activation functions. Piece-wise linear is usually based on approximating complex non-linear curves using several linear segments. Each linear segment could be represented using a slope and an intercept. The complete range of a non-linear activation function may be divided into smaller regions such that each region could be approximated using a linear segment. These regions could be of variable range, but executing the linear functions, even though there can be a greater number of linear functions, can be more efficient than executing the non-linear activation function itself. The slope and intercept of linear segments can be stored in a LUT. Accuracy increase usually requires more entries in the LUT. A LUT address generation logic is usually used to generate the address of the slopes and intercepts with the LUT that correspond to the linear segment within which the input lies.

For a DNN accelerator to be versatile, flexible, and future proof, it can be important to have DNN accelerators with the capability to be programmed for various types of activation functions as the need arises. Many currently available solutions for approximating activation functions are based on Digital Signal Processor (DSP) based kernel-based implementations. Another variant of implementing activation functions is based on Taylor series approximation. However, these currently available solutions suffer from the lack the flexibility.

Embodiments of the present disclosure provide systems and methods for approximating activation functions with programmable LUTs. A programmable architecture may be used to approximate non-linear activation functions using piece-wise linear approximation. In an example, a module implemented in software may determine linear functions approximating a non-linear activation function and configure a LUT implemented in a processing unit with parameters of the linear functions so that the processing unit can execute the non-linear activation function using the LUT. The module may configure the LUT based on data distribution of the input of the activation function, desirable data type of the output of the activation function, an area budget for the LUT (e.g., the size of an area in the processing unit that is available for implementing the LUT), other types of factors, or some combination thereof.

In various embodiments of the present disclosure, a processing unit executing an activation function receives data elements (“input data elements”) and applies the activation function on the input data elements to compute output data elements. The output data elements may constitute the output of the activation function. When the activation function is approximated by linear functions, the processing unit would apply the linear functions on the input data elements to compute output data elements. These output data elements may constitute the approximated output of the activation function. The approximated output may be the same or similar as the real output of the activation function. The input data elements may have a floating-point data type, such as FP32, FP16, BF16, FP8, and so on. FP stands for floating point. BF stands for brain floating point. The output data elements may also have a floating-point data type. In some embodiments, the data type of the output data elements may be the same as the data type of the input data elements. In other embodiments, the data type of the output data elements may be different from the data type of the input data elements. For example, the output data elements may have a data type that has a higher precision than the data type of the input data elements. The LUT used for approximating the activation function may support various data types and can facilitate computation of output data elements with various data types. An example of the LUT may include a set of entries. An entry may include the parameters of a single linear function.

To approximate an activation function, exponents in an input range of the activation function may be identified. The input range may be the range of the input data elements of the activation function. The input range may be divided into input segments, each of which corresponds to a different exponent and includes input data elements having the exponent. Target accuracies may be assigned to the identified exponents based on a statistics analysis of the input data elements. The target accuracies are range specific, meaning a target accuracy is specific to the corresponding input segment. Different input segments may have different target accuracies. In an example, for each input segment, a distribution frequency may be determined for the input segment. The distribution frequency may be a value indicate how often the activation function receives input data elements falling into the input segment. The distribution frequency may indicate the number of input data elements falling into the input segment. Additionally or alternatively, the distribution frequency may indicate a ratio of the number of input data elements falling into the input segment to the total number of the input data elements of the activation function to determine a ratio. A higher target accuracy may be assigned to an input segment having a higher distribution frequency. The target accuracy of an input segment will be used to determine the linear functions(s) to be used to approximate the activation function for input data elements falling into the input segment. Compared with an input segment having a lower target accuracy, more linear functions may be used to approximate the activation function for an input segment having a higher target accuracy and more entries in the LUT and more area in hardware will be used for the input segment.

An iterative process may be used to determine one or more linear functions for an input element. The iterative process may start with determining one linear function for the input element. An error of the approximation by the linear function may be determined and compared with the target accuracy of the input element. When the error is within the target accuracy, one or more parameters of the linear function may be stored in an entry of a LUT. When the error is beyond the target accuracy, multiple linear functions may be used to approximate the input segment. For instance, the input segment may be divided into multiple new input segments, each of which may be approximated by a different linear function. When the error of the approximation by a linear function for a new input segment is within the target accuracy, the parameters of the linear function may be stored in the LUT. When the error of the approximation by a linear function for a new input segment is beyond the target accuracy, the new input segment may be further divided for approximation by multiple linear functions. This process may continue till linear functions for all the input segments of the activation functions are found and the parameters of the linear functions are stored in the LUT.

The LUT may have an area budget. The size of the LUT, such as the number of entries used for storing the parameters of the linear functions, may be compared with the area budget. When the size of the LUT exceeds the area budget, the target accuracy of an input segment (or target accuracies of multiple input segments) may be adjusted. For instance, the target accuracy of an input segment may be reduced so that less linear functions will be used for the input segment, which can reduce the number of LUT entries needed for the input segment and therefore, decrease the size of the LUT.

Different from many currently available approaches for approximating activation functions, the present disclosure provides a flexible LUT generation framework that can improve or even maximize overall accuracy of activation function approximation within area budget. The flexible LUT generation framework can facilitate exploration of accuracy versus area trade off. As the output of activation function is approximated with higher accuracies for input elements having higher distribution frequencies, overall accuracy of the layer or the DNN can be improved and the limited area for the LUT is better utilized. Also, area saving can be achieved by reducing the target accuracy and number of LUT entries for input segments having lower distribution frequencies. Additionally, the flexible LUT generation framework can support various LUT datatypes and allow selection of LUT datatype based on the input or output of the activation function.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

Example DNN

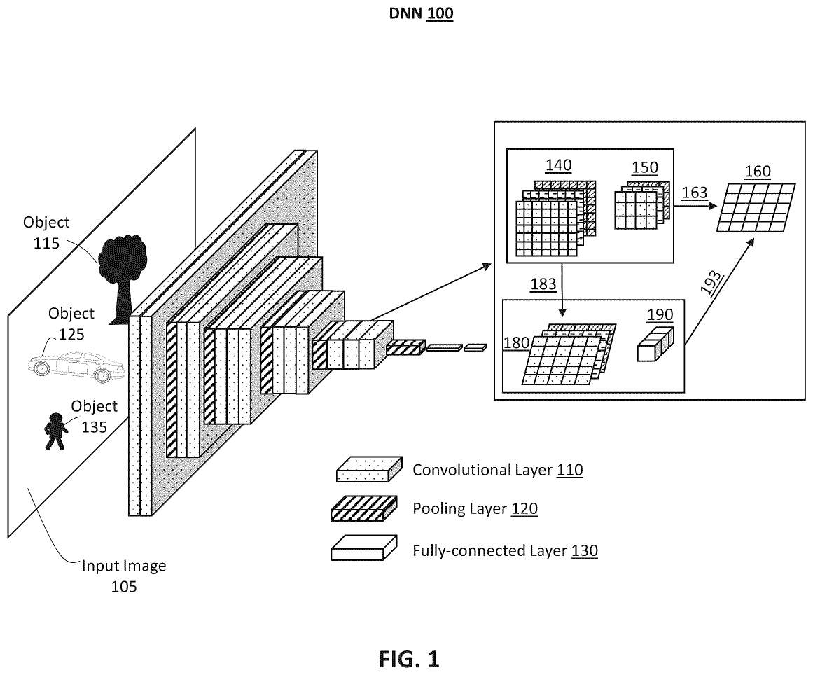

FIG. 1 illustrates an example DNN 100, in accordance with various embodiments. The DNN 100 may be an example of a teacher network or an example of a student network. For the purpose of illustration, the DNN 100 in FIG. 1 is a CNN. In other embodiments, the DNN 100 may be other types of DNNs. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully-connected layers 130 (individually referred to as “fully-connected layer 130”). In other embodiments, the DNN 100 may include fewer, more, or different layers. In an inference of the DNN 100, the layers of the DNN 100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as input feature map (IFM) 140) and a filter 150. As shown in FIG. 1, the IFM 140 is represented by a 7×7×3 three-dimensional (3D) matrix. The IFM 140 includes 3 input channels, each of which is represented by a 7×7 two-dimensional (2D) matrix. The 7×7 2D matrix includes 7 input elements (also referred to as input points) in each row and 7 input elements in each column. The filter 150 is represented by a 3×3×3 3D matrix. The filter 150 includes 3 kernels, each of which may correspond to a different input channel of the IFM 140. A kernel is a 2D matrix of weights, where the weights are arranged in columns and rows. A kernel can be smaller than the IFM. In the embodiments of FIG. 1, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as OFM 160). The OFM 160 is represented by a 5×5 2D matrix. The 5×5 2D matrix includes 5 output elements (also referred to as output points) in each row and 5 output elements in each column. For the purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D matrix of output elements. As such, the 2D output matrix (i.e., the OFM 160) from the standard convolution 163 is referred to as an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes 3 output channels, each of which is represented by a 5×5 2D matrix. The 5×5 2D matrix includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is rectified linear unit (ReLU). ReLU is a calculation that returns the value provided as input directly, or the value zero if the input is zero or less. The convolutional layer 110 may receive several images as input and calculate the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 perform a convolution on the OFM 160 with new kernels and generate a new feature map. The new feature map may also be normalized and resized. The new feature map can be kernelled again by a further subsequent convolutional layer 110, and so on.

In some embodiments, a convolutional layer 110 has four hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presence of features in the patches of the feature maps. A pooling layer 120 is placed between two convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU, etc.) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of two pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully-connected layers 130 are the last layers of the DNN. The fully-connected layers 130 may be convolutional or not. The fully-connected layers 130 receive an input operand. The input operand defines the output of the convolutional layers 110 and pooling layers 120 and includes the values of the last feature map generated by the last pooling layer 120 in the sequence. The fully-connected layers 130 apply a linear combination and an activation function to the input operand and generate a vector. The vector may contain as many elements as there are classes: element i represents the probability that the image belongs to class i. Each element is therefore between 0 and 1, and the sum of all is worth one. These probabilities are calculated by the last fully-connected layer 130 by using a logistic function (binary classification) or a SoftMax function (multi-class classification) as an activation function.

In some embodiments, the fully-connected layers 130 classify the input image 105 and return an operand of size N, where N is the number of classes in the image classification problem. In the embodiments of FIG. 1, N equals 3, as there are 3 objects 115, 125, and 135 in the input image. Each element of the operand indicates the probability for the input image 105 to belong to a class. To calculate the probabilities, the fully-connected layers 130 multiply each input element by weight, make the sum, and then apply an activation function (e.g., logistic if N=2, SoftMax if N>2). This is equivalent to multiplying the input operand by the matrix containing the weights. In an example, the vector includes 3 probabilities: a first probability indicating the object 115 being a tree, a second probability indicating the object 125 being a car, and a third probability indicating the object 135 being a person. In other embodiments where the input image 105 includes different objects or a different number of objects, the individual values can be different.

Example DNN System

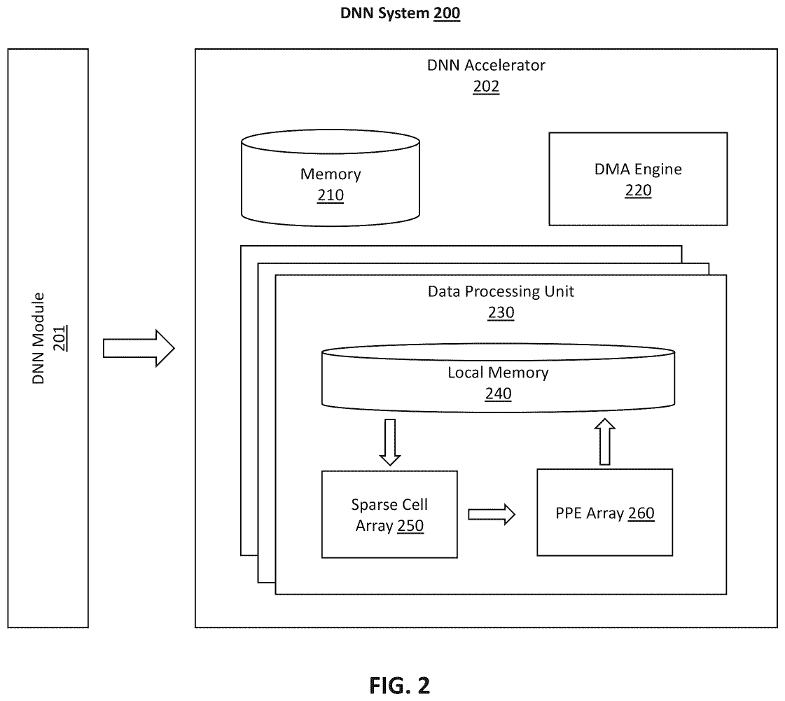

FIG. 2 is a block diagram of a DNN system 200, in accordance with various embodiments. The whole DNN system 200 or a part of the DNN system 200 may be implemented in one or more computing devices, such as the computing device 2000 in FIG. 20. The DNN system 200 can generate and execute DNNs, such as the DNN 100 in FIG. 1. As shown in FIG. 2, the DNN system 200 includes a DNN module 201 and a DNN accelerator 202. In other embodiments, alternative configurations, different or additional components may be included in the DNN system 200. For instance, the DNN system 200 may include multiple DNN modules or multiple DNN accelerators. Further, functionality attributed to a component of the DNN system 200 may be accomplished by a different component included in the DNN system 200 or a different system. In some embodiments, the DNN module 201 and DNN accelerator 202 may include different types of processing units. The DNN module 201 and DNN accelerator 202 may be implemented in the same chip or separate chips.

The DNN module 201 facilitates generation and deployment of DNNs. In some embodiments, the DNN module 201 may generate and train DNNs. For instance, the DNN module 201 can define the layered architecture of a DNN. The DNN module 201 can also determine the internal parameters of the DNN through a DNN training process. The DNN module 201 may also determine one or more hyperparameters that define how the DNN is trained. An example hyperparameter is a sparsity ratio that defines the sparsity level of one or more deep learning tensors for the DNN. The DNN module 201 may also compress DNNs, e.g., during or after training.

The DNN module 201 may deploy trained, compressed, or validated DNNs for use in deep learning applications. In some embodiments, the DNN module 201 may distribute trained, compressed, or validated DNNs to devices or systems which may use the DNNs to perform tasks (e.g., image classification, motion planning, etc.) for which the DNNs were trained. In other embodiments, the DNN module 201 may facilitate deployment of the DNNs using the DNN accelerator 202. For instance, the DNN module 201 may receive data from a device or system coupled with the DNN system 200 and input the received data (or data generated by the DNN module 201, e.g., based on the received data) into a DNN. The DNN module 201 may generate instructions (e.g., configuration files) that control the operation of the DNN accelerator 202 during the DNN execution. The DNN module 201 may receive an output of the DNN from the DNN accelerator 202. The DNN module 201 may transmit the output of the DNN (or a result of processing the output of the DNN by the DNN module 201) to the device or system.

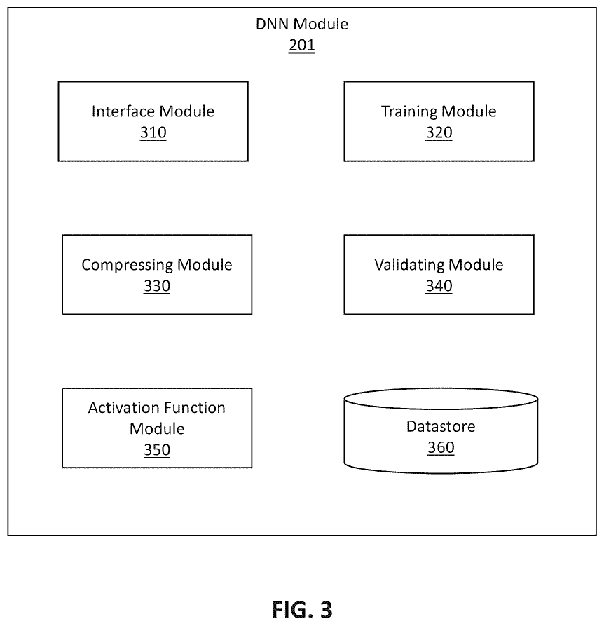

The DNN module 201 may control execution processes of trained, compressed, or validated DNNs. For instance, the DNN module 201 may facilitate approximation of non-linear activation functions with other functions including linear functions. The non-linear activation functions may be executed, e.g., by the PPE array 260, by executing these other functions. The outputs of these other functions may be approximated outputs of the non-linear activation functions and may be used in subsequent deep learning operations in the DNNs. The DNN module 201 may partition the input range of a non-linear activation function into multiple segments and approximate the non-linear activation function within the segments using various functions. In some embodiments, the DNN module 201 may generate a configuration descriptor for a non-linear activation function. The configuration descriptor may store information to be used for approximating the non-linear activation function. For instance, the configuration descriptor may include a LUT storing slopes and intercepts of linear functions. Certain aspects of the DNN module 201 are provided below in conjunction with FIG. 3.

The DNN accelerator 202 executes DNNs provided by the DNN module 201. For instance, the DNN accelerator 202 can perform DNN execution, e.g., by running deep learning operations in the DNNs, for training DNNs or for using the trained/compressed/validated DNNs to perform tasks. As shown in FIG. 2, the DNN accelerator 202 includes a memory 210, a DMA (direct memory access) engine 220, and data processing units 230 (individually referred to as “data processing unit 230”). In other embodiments, alternative configurations, different or additional components may be included in the DNN accelerator 202. For example, the DNN accelerator 202 may include more than one memory 210 or DMA engine 220. As another example, the DNN accelerator 202 may include a single data processing unit 230. Further, functionality attributed to a component of the DNN accelerator 202 may be accomplished by a different component included in the DNN accelerator 202 or by a different system. A component of the DNN accelerator 202 may be implemented in hardware, software, firmware, or some combination thereof.

The memory 210 stores data associated with deep learning operations performed by the DNN accelerator. In some embodiments, the memory 210 may store data to be used by the data processing units 230 for DNN execution. For example, the memory 210 may store weights, such as weights of convolutional layers, which are determined by training DNNs. As another example, the memory 210 may store inputs to DNNs or outputs of DNNs. The memory 210 may also store data generated by the data processing units 230 from performing deep learning operations in DNNs. Example deep learning operations include convolutions (also referred to as “convolutional operations”), pooling operations, elementwise operations, activation functions, other types of deep learning operations, or some combination thereof. The memory 210 may be a main memory of the DNN accelerator 202. In some embodiments, the memory 210 includes one or more dynamic random-access memories (DRAMs).

The DMA engine 220 facilitates data transfer between the memory 210 and local memories of the data processing units 230. For example, the DMA engine 220 can read data from the memory 210 and write data into a local memory of a data processing unit 230. As another example, the DMA engine 220 can read data from a local memory of a data processing unit 230 and write data into the memory 210. The DMA engine 220 provides a DMA feature that allows the data processing unit 230 to initiate data transfer between the memory 210 and the local memories of the data processing units 230 and to perform other operations while the data transfer is in being conducted. In some embodiments, the DMA engine 220 may read tensors from the memory 210, modify the tensors in a way that is optimized for the data processing unit 230 before it writes the tensors into the local memories of the data processing units 230.

The data processing units 230 can perform deep learning operations in DNNs. For instance, a data processing unit 230 may run a deep learning operation in a DNN layer, or a portion of the deep learning operation, at a time. The data processing units 230 may be capable of running various types of deep learning operations, such as activation functions, convolution, pooling, elementwise operation, linear operation, non-linear operation, and so on. In an example, a data processing unit 230 may perform convolutions, e.g., standard convolution or depthwise convolution. In some embodiments, the data processing unit 230 receives an input tensor and one or more convolutional kernels and performs a convolution with the input tensor and convolutional kernels. The result of the convolution may be an output tensor, which can be further computed, e.g., by the data processing unit 230 or another data processing unit 230. In some embodiments, the operations of the DNN layers may be run by multiple data processing units 230 in parallel. For instance, multiple data processing units 230 may each perform a portion of a workload for a convolution. Data may be shared between the data processing units 230. A data processing unit 230 may also be referred to as a compute tile. In some embodiments, each data processing unit 230 may be a processing unit.

In the embodiments of FIG. 2, each data processing unit 230 includes a local memory 240, a sparse cell array 250, and a PPE array 260. Some or all the components of the data processing unit 230 can be implemented on the same chip. In other embodiments, alternative configurations, different or additional components may be included in the data processing unit 230. For instance, the data processing unit 230 may include an additional module for loading data into the sparse cell array 250 from the local memory 240 or an additional module for draining data from the PPE array 260 into the local memory 240. Further, functionality attributed to a component of the data processing unit 230 may be accomplished by a different component included in the data processing unit 230, a different data processing unit 230, another component of the DNN accelerator 202, or a different system. A component of the data processing unit 230 may be implemented in hardware, software, firmware, or some combination thereof. Data processing units may also be referred to as compute blocks.

The local memory 240 is local to the corresponding data processing unit 230. In the embodiments of FIG. 2, the local memory 240 is inside the data processing unit 230. In other embodiments, the local memory 240 may be outside the data processing unit 230. Data in the local memory 240 may be transferred to or from the memory 210, e.g., through the DMA engine 220. In some embodiments, data in the local memory 240 may be transferred to or from the local memory of another data processing unit 230. The local memory 240 may store data received, used, or generated by the sparse cell array 250 and the PPE array 260. Examples of the data may include input activations, weights, output activations, sparsity bitmaps, and so on.

In some embodiments, the local memory 240 includes one or more static random-access memories (SRAMs). The local memory 240 may be byte-addressable, and each memory address identifies a single byte (eight bits) of storage. In some embodiments, the local memory 240 may include memory banks. The number of data banks in the local memory 240 may be 16, 64, 128, 256, 512, 1024, 2048, or other numbers. A memory bank may include a plurality of storage units. In an example, a data bank may include 8, 16, 64, or a different number of storage units. A memory bank or a storage unit in a memory bank may have a memory address. In an example, a storage unit may store a single byte, and data larger than a single byte may be stored in storage units with consecutive memory addresses, i.e., adjacent storage units. For instance, a storage unit can store an integer number in the INT8 format, versus two storage units may be needed to store a number in the FP16 or BF16 format, which has 16 bits. In some embodiments, 16 bits can be transferred from the local memory 240 in a single read cycle. In other embodiments, 16 bits can be transferred from the local memory 240 in multiple read cycles, such as two cycles.

The sparse cell array 250 may include sparse cells arranged in columns, or columns and rows. Each sparse cell may include an array of MAC units that can perform MAC operations. In some embodiments (e.g., embodiments where the data processing unit 230 executes a convolutional layer), a computation in an MAC unit may be an MAC operation on an activation operand and a weight operand. The activation operand is an activation tensor that may include one or more activations in the input tensor of the convolution. Different activations may be in different input channels. The weight operand is a weight tensor that may include one or more weights in the filter of the convolution. The values of the weights are determined through training the DNN. The weights in the weight operand may be in different input channels.

In some embodiments, an MAC unit includes one or more multipliers for performing multiplications. An MAC unit may also include one or more accumulators (“adders”) for performing accumulations. A column of MAC units is referred to as an MAC column. An MAC column may be associated with one or more MAC lanes. An MAC lane is a path for loading data into an MAC column. An MAC lane may be also referred to as a data transmission lane or data loading lane. An MAC column may have multiple MAC lanes. The loading bandwidth of the MAC column is an aggregation of the loading bandwidths of all the MAC lanes associated with the MAC column. With a certain number of MAC lanes, data can be fed into the same number of independent MAC units simultaneously. In some embodiments where an MAC column has four MAC lanes for feeding activations or weights into the MAC column and each MAC lane may have a bandwidth of 16 bytes, the four MAC lanes can have a total loading bandwidth of 64 bytes.

In some embodiments, the sparse cell array 250 may be capable of depthwise convolution, standard convolution, or both. In a depthwise convolution, an MAC unit may perform an MAC operation that includes a sequence of multiplications for an input operand and a weight operand. Each multiplication in the sequence (also referred to as a cycle) is a multiplication of a different activation in the input operand with a different weight in the weight operand. The activation and weight in the same cycle may correspond to the same channel. The sequence of multiplication produces a product operand that includes a sequence of products. The MAC operation may also include accumulations in which multiple product operands are accumulated to produce an output operand of the MAC unit. The sparse cell array 250 may output multiple output operands at a time, each of which is generated by a different MAC unit. In a standard convolution, MAC operations may include accumulations across the channels. For instance, as opposed to generating an output operand, a MAC unit may accumulate products across different channels to generate a single output point.

In some embodiments, the sparse cell array 250 may include sparsity acceleration logic for facilitating sparsity acceleration. For instance, each sparse cell in the sparse cell array 250 may include one or more sparsity modules. In an example, each MAC column or each MAC row may have a corresponding sparsity module that accelerates MAC operations in the MAC column or MAC row. In some embodiments, a sparsity module accelerates computations in the sparse cell array 250 based on sparsity in activations or sparsity in weights. The sparsity module may include a storage unit that stores a sparsity tensor. The sparsity tensor may be an activation sparsity tensor, a weight sparsity tensor, or a combination of both.

The sparsity module may use the sparsity tensor to identify which data elements of the dense tensor correspond to data elements of the sparse tensor. Each identified data element of the dense tensor and the corresponding data element of the sparse tensor may constitute an activation-weight pair for an MAC operation. For instance, the identified data element of the dense tensor will be multiplied with the corresponding data element of the sparse tensor in the MAC operation. The sparsity module may select one or more data elements of the dense tensor based on one or more sparsity elements of the sparsity tensor that correspond to one or more nonzero valued data elements of the dense format of the sparse tensor. The sparsity module can forward the identified activation-weight pairs to the MAC units. Other data elements of the dense tensor would be skipped and not computed by the MAC units to accelerate computation in the sparse cell array 250, as these data elements will not contribute to the result of the MAC operation.

The PPE array 270 processes outputs of the sparse cell array 250. In some embodiments, the PPE array 260 executes activation functions, including non-linear activation functions. The PPE array 260 may receive outputs of the sparse cell array 250 as inputs to the activation functions. An input to an activation function may be a tensor including a plurality of input data elements. The tensor may be an output tensor of a DNN layer. In some embodiments, the data elements to be input into an activation function may be in a range, which is the input range of the activation function. The PPE array 270 may compute outputs of non-linear activation functions by using linear functions that approximate the non-linear activation functions. For instance, in the execution of a non-linear activation function, the PPE array 270 may apply a linear function on some or all input data elements and use the outputs of the linear function as the approximated outputs of the non-linear activation function. To apply the linear function on input data elements, the PPE array 270 may use data stored in a programmable LUT. The programmable LUT may be included in the PPE array 270. The data stored in the programmable LUT may be determined by the DNN module 201. In some embodiments, the PPE array 270 may output a predetermined value as outputs of a non-linear activation function for some input data elements. The predetermined value may be stored in a saturation table in the PPE array 270.

In some embodiments, the PPE array 260 may transmit the outputs of the activation functions to the local memory 240. The outputs of the activation functions may be retrieved later by the sparse cell array 250 from the local memory 240 for further computation. For instance, the PPE array 260 may receive an output tensor of a DNN layer from the sparse cell array 250 and computes one or more activation functions on the output tensor. The results of the computation by the PPE array 260 may be stored in the local memory 240 and later used as input tensor of the next DNN layer.

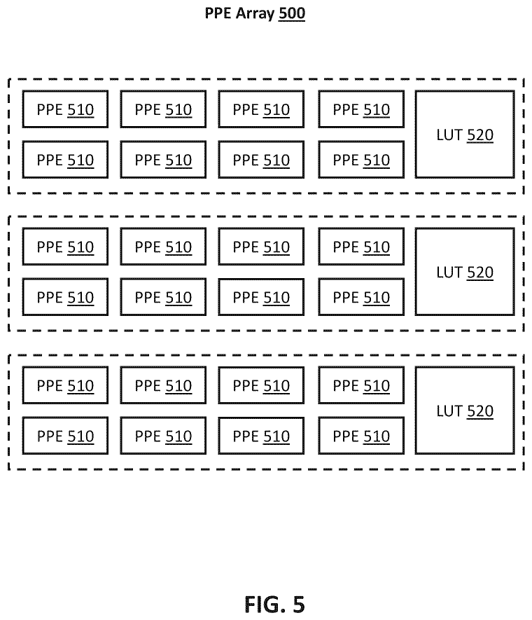

In addition or alternative to activation functions, the PPE array 260 may perform other types of post processing on outputs of the sparse cell array 250. For example, the PPE array 260 may apply a bias or scale on an output of the sparse cell array 250 before executing activation function(s). As another example, the PPE array 260 may apply a bias or scale on approximated outputs of activation function(s). Certain aspects of the PPE array 260 are described below in conjunction with FIG. 5.

FIG. 3 is a block diagram of the DNN module 201, in accordance with various embodiments. In the embodiments of FIG. 3, the DNN module 201 includes an interface module 310, a training module 320, a compressing module 330, a validating module 340, an activation function module 350, and a datastore 360. In other embodiments, alternative configurations, different or additional components may be included in the DNN module 201. Further, functionality attributed to a component of the DNN module 201 may be accomplished by a different component included in the DNN module 201 or a different module or system.

The interface module 310 facilitates communications of the DNN module 201 with other modules or systems. For example, the interface module 310 establishes communications between the DNN module 201 with an external database to receive data that can be used to train DNNs or input into DNNs to perform tasks. As another example, the interface module 310 supports the DNN module 201 to distribute DNNs to other systems, e.g., computing devices configured to apply DNNs to perform tasks.

The training module 320 trains DNNs by using a training dataset. The training module 320 forms the training dataset. In an embodiment where the training module 320 trains an DNN to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the DNN, and the rest of the training dataset may be held back as a validation subset used by the validating module 340 to validate performance of a trained DNN. The portion of the training dataset not including the tuning subset and the validation subset may be used to train the DNN.

The training module 320 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 1, 5, 10, 50, 100, 500, 1000, or even larger.

The training module 320 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully-connected layers, normalization layers, SoftMax or logistic layers, and so on. The convolutional layers of the DNN abstract the input image to a feature map that is represented by a tensor specifying the feature map height, the feature map width, and the feature map channels (e.g., red, green, blue images include 2 channels). A pooling layer is used to reduce the spatial volume of input image after convolution. It is used between two convolution layers. A fully-connected layer involves weights, biases, and neurons. It connects neurons in one layer to neurons in another layer. It is used to classify images between different categories by training.

In the process of defining the architecture of the DNN, the training module 320 also adds an activation function to a hidden layer or the output layer. An activation function of a layer transforms the weighted sum of the input of the layer to an output of the layer. The activation function may be, for example, a ReLU activation function, a tangent activation function, or other types of activation functions.

After the training module 320 defines the architecture of the DNN, the training module 320 inputs a training dataset into the DNN. The training dataset includes a plurality of training samples. An example of a training sample includes an object in an image and a ground-truth label of the object. The training module 320 modifies the parameters inside the DNN (“internal parameters of the DNN”) to minimize the error between labels of the training objects that are generated by the DNN and the ground-truth labels of the objects. The internal parameters include weights of filters in the convolutional layers of the DNN. In some embodiments, the training module 320 uses a cost function to minimize the error.

The training module 320 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 320 finishes the predetermined number of epochs, the training module 320 may stop updating the parameters in the DNN. The DNN having the updated parameters is referred to as a trained DNN.

The compressing module 330 compresses DNNs. For instance, the compressing module 330 may add pruning operations to DNN layers to reduce computational complexity or memory usage. A pruning operation may prune weight tensors of a DNN layer by changing one or more nonzero valued weights of the layer to zeros. The modification may be done before, during, or after training. Weights may be pruned during training, during inference, or a combination of both. The compressing module 330 may determine a sparsity ratio for a DNN layer. The sparsity ratio may be a ratio of the number of zero-valued weight to the total number of weights in the layer. The compressing module 330 may perform the pruning operation till the sparsity ratio of the DNN layer meets a target sparsity ration, such as 10%, 20%, 20%, 30%, 50%, and so on.

In some embodiments, the compressing module 330 may select one or more layers in a DNN and modify each selected layer with a pruning operation. For instance, the compressing module 330 may select computationally complex layers, such as layers with large filters. For a pruning operation of a layer or of a type of layer, the compressing module 330 may determine a weight threshold that would not cause a loss of the accuracy of the DNN to exceed an accuracy loss constraint. A pruning operation may modify weights having absolute values above the weight threshold to zeros and leave the other weights unchanged. The weight pruning can reduce memory storage as zero-valued weights may not be stored. Also, the number of operations in the layer can be reduced as computations on zero-valued weights can be skipped without impacting the output of the layer. In some embodiments, the compressing module 330 may also measure energy saving, final DNN accuracy, or layer-wise sparsity caused by pruning operations.

After compressing a DNN, the compressing module 330 may fine tune the DNN, e.g., through a retraining process. The compressing module 330 may fine tunes DNNs after weights are pruned. In some embodiments, the fine-tuning process is a retraining or further training process. For instance, after weights in a DNN are pruned, the compressing module 330 may further train the DNN by inputting a training dataset into the DNN. The values of the unpruned weights in the DNN may be modified based on outputs of the DNN and ground-truth labels of the training samples in the training dataset. In some embodiments, the values of the pruned weights (i.e., zero) are not changed during the fine-tuning process. For instance, the compressing module 330 may place a mask over a pruned weight block and the mask can prevent values in the pruned weight blocks from being changed during the fine-tuning process. In other embodiments, the values of all weights, including the pruned weights, may be changed during the fine-tuning process. After one or more cycles of retraining and weight changing by the compressing module 330, the compressing module 330 may perform a new pruning process, e.g., by selecting weight blocks and pruning the selected weight blocks. In some embodiments, the weight pruning process may be repeated multiple times before the fine-tuning process is done.

In some embodiments, the number of epochs in the fine-tuning process may be different from the number of epochs in the training process in which the pre-pruning values of the weights are determined. For instance, the fine-tuning process may have less epochs than the training process. In an example, the number of epochs in the fine-tuning process may be relatively small, such as 2, 2, 3, 5, and so on.

The validating module 340 verifies accuracy of trained or compressed DNNs. In some embodiments, the validating module 340 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validating module 340 may determine an accuracy score measuring the precision, recall, or a combination of precision and recall of the DNN. The validating module 340 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validating module 340 may compare the accuracy score with a threshold score. In an example where the validating module 340 determines that the accuracy score of the augmented model is less than the threshold score, the validating module 340 instructs the training module 320 to re-train the DNN. In one embodiment, the training module 320 may iteratively re-train the DNN until the occurrence of a stopping condition, such as the accuracy measurement indication that the DNN may be sufficiently accurate, or a number of training rounds having taken place.

The activation function module 350 programs LUTs for programmable piece-wise linear approximation of non-linear activation functions in DNNs. The LUTs may be implemented in a data processing unit, such as the data processing unit 230. In an example, the LUTs may be implemented in the PPE array 260. A linear function may be denoted as y=ax+b, where a denotes the slope of the linear function, b denotes the intercept of the linear function, x denotes the input of the linear function, and y denotes the output of the linear function. The intercept and slope may be the parameters of the linear function and may be stored as a single entry in the LUT.

In an example process of approximating a non-linear activation function, the activation function module 350 may determine the input range of the non-linear activation function. The input range may be a range that includes some or all possible data elements that will be input into the non-linear activation function. The input range may depend on the datatypes (or data formats) of the input data elements. The activation function module 350 may support various data formats, including floating-point formats, such as FP32, FP16, BF16, FP8, and so on. The input data elements may be computed in a DNN layer, such as a convolutional layer, fully-connected layer, pooling layer, and so on. In an example, the input data elements may be results of a convolution in the DNN. The activation function module 350 may identify the exponents in the input range and divide the input range into input segments. An input segment is a portion of the input range that has input data elements having the same exponent. The input segments may correspond to the identified exponents, respectively.

The activation function module 350 may analyze statistics of the input data elements with respect to the input segments. For instance, the activation function module 350 may determine distribution frequencies of the input segments. Using the distribution frequencies, the activation function module 350 may determine target accuracies of approximating the activation function for the input segments based on the distribution frequencies of the input segments. An input segment having a higher distribution frequency may have a higher target accuracy. For each input segment, the activation function module 350 may determine one or more linear functions that can approximate the activation function within the target accuracy. In some embodiments, the activation function module 350 may determine one linear function for one input element. In other embodiments, the activation function module 350 may determine multiple linear functions for one input segment. The linear functions may be used to approximate the activation function for different portions of the input segment. A linear function may have one or more parameters that will be used to compute approximated output of the activation function. Examples of the parameters include intercepts, slopes, or other types of parameters of the linear functions.

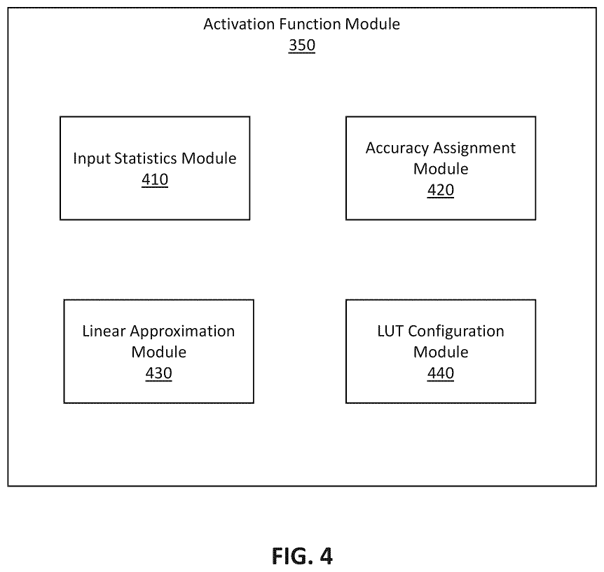

The activation function module 350 may program the parameters of the linear functions into the LUT so that the LUT includes the parameters of the linear functions. In some embodiments, the activation function module 350 may determine whether the size of the LUT meets an area budget for the LUT. When the size of the LUT exceeds the area budget, the activation function module 350 may modify one or more target accuracies of one or more input segments in the input range based on the area budget and re-determine the linear function for the one or more input segments. In some embodiments, the activation function module 350 may also select a datatype for the LUT. The parameters of the linear functions stored in the LUT will have the selected datatype. The activation function module 350 may select the datatype for the for the LUT based on the input or output of the activation function. Certain aspects of the activation function module 350 is described below in conjunction with FIG. 4.

The datastore 360 stores data received, generated, used, or otherwise associated with the DNN module 201. For example, the datastore 360 stores the datasets used by the training module 320 and validating module 340. The datastore 360 may also store data generated by the training module 320 and validating module 340, such as the hyperparameters for training DNNs, internal parameters of trained DNNs (e.g., weights, etc.), data for sparsity acceleration (e.g., sparsity bitmap, etc.), and so on. The datastore 360 may store configuration parameters generated by the activation function module 350. In the embodiment of FIG. 3, the datastore 360 is a component of the DNN module 201. In other embodiments, the datastore 360 may be external to the DNN module 201 and communicate with the DNN module 201 through a network.

FIG. 4 is a block diagram of the activation function module 350, in accordance with various embodiments. As described above, the activation function module 350 may configure a LUT for approximating a non-linear activation function with linear functions. In the embodiments of FIG. 4, the activation function module 350 includes an input statistics module 410, an accuracy assignment module 420, a linear approximation module 430, and a LUT configuration module 440. In other embodiments, alternative configurations, different or additional components may be included in the activation function module 350. Further, functionality attributed to a component of the activation function module 350 may be accomplished by a different component included in the activation function module 350, a component in the DNN module 201, or a different module or system.

The input statistics module 410 analyzes statistics of the input data elements of the non-linear activation function. The input data elements may be computed in a DNN layer, such as a convolutional layer, fully-connected layer, pooling layer, and so on. In an example, the input data elements may be results of a convolution in the DNN. In some embodiments, the input statistics module 410 determines the input range of the non-linear activation function. The input range may be a range that includes some or all input data elements of the non-linear activation function. The input statistics module 410 may determine the input range based on the datatypes (or data formats) of the input data elements. In an example where the datatype of the input data elements is FP8, the input statistics module 410 may determine that the input range is from −57344 to 57344. In an example where the datatype of the input data elements is FP16, the input statistics module 410 may determine that the input range is from −65504 to 65504. In an example where the datatype of the input data elements is BF16, the input statistics module 410 may determine that the input range is from −3.39×10³⁸ to 3.39×10³⁸. In an example where the datatype of the input data elements is FP32, the input statistics module 410 may determine that the input range is from −3.4×10³⁸ to 3.4×10³⁸.

The input statistics module 410 may partition the input range into input segments. In some embodiments, the input statistics module 410 may identify the exponents in the input range and divide the input range into input segments based on the identified exponents. For instance, an input segment may be the range of input data elements having the same exponent. The number of input segments in an input range may vary, e.g., depending on the values of the input data elements, the datatypes of the input data elements, etc. In some embodiments, the maximum number of exponents for input data elements having the FP32 or BF16 format may be 256. The maximum number of exponents for input data elements having the FP16 format may be 32. The maximum number of exponents for input data elements having the FP8 format may be 16.

The input statistics module 410 may determine distribution frequencies of the input segments. For example, the input statistics module 410 may determine how many input data elements fall into each of the input segments. As another example, the input statistics module 410 may compute a ratio of the number of input data elements in an input segment to the total number of input data elements in the input range. In some embodiments, the input statistics module 410 may rank the input segments based on their distribution frequencies.

The accuracy assignment module 420 assigns accuracies to the input segments based on statistics of the input data elements. The assigned accuracies may be range specific. For instance, an assigned accuracy is specific to a particular input segment. In some embodiments, the accuracy assignment module 420 determines a unit of least precision (ULP) for an input segment and uses the ULP as the target unit of the input segment. ULP is also referred to as unit in the last place and may be used as a measure of accuracy. ULP indicates the spacing between two consecutive floating-point numbers. ULP may be the value represented by the least significant digit (i.e., the right most digit) when it is 1. ULP may be different for different exponents. For instance, the ULP for an exponent having a value of 15 may be approximately 0.0009765625, the ULP for an exponent having a value of 23 may be approximately 0.25. The assigned accuracy of an input segment may be the target accuracy or threshold accuracy of the approximation of the activation function for the input segment.

In some embodiments, the accuracy assignment module 420 may determine the target accuracy of an input segment based on its distribution frequency and an area budget of the LUT. The accuracy assignment module 420 may assign higher target accuracies to input segments having higher distribution frequencies. Higher target accuracies may require more LUT entries for storing the parameters of the linear functions and therefore, consume more area in the data processing unit. The accuracy assignment module 420 may also ensure that the target accuracies of the input segment would not be too high to cause the area needed for the LUT exceeds the area that is available for the LUT in the data processing unit. The area (or the size of the area) that is available for the LUT in the data processing unit may be an arear budget for the LUT. In some embodiments (e.g., embodiments where the area needed for the LUT exceeds the area budget), the accuracy assignment module 420 may adjust one or more already-determined target accuracies of one or more input segments to reduce the area needed by the LUT.

In an embodiment, the activation function module 350 may determine the size of the LUT, e.g., after the linear approximation module 430 determines the linear functions used to approximate the activation function or after the LUT configuration module 440 configures the LUT. The activation function module 350 may compare the LUT size with the area budget for the LUT. In embodiments where the size of the LUT exceeds the area budget, the activation function module 350 may modify one or more target accuracies of one or more input segments in the input range. For instance, the activation function module 350 may decrease the target accuracy of an input segment so that the number of linear functions for the input segment may be reduced and therefore, which can reduce the size of the LUT to meet the area budget as the number of parameters to be programmed into the LUT is reduced.

The linear approximation module 430 determines linear functions that approximate the activation function for the input segments. In some embodiments, the linear approximation module 430 may determine linear functions for the input segments separately. For instance, the linear approximation module 430 may select an input segment from the input range or select an exponent from the exponents in the input range. The linear approximation module 430 may perform an iterative process to determine one or more linear functions for the selected input segment. An example of the iterative process may start with determining one linear function for the input segment. For instance, the linear approximation module 430 may determine the intercept and slope of the linear function based on the first input data element in the input segment (e.g., the input data element having the lowest value in the input segment), the output data element corresponding to the first input data element, the last data element in the input segment (e.g., the input data element having the highest value in the input segment), the output data element corresponding to the last input data element.

After the intercept and slope of the linear function is determined, the linear approximation module 430 may compute an error of the linear function approximating the activation function for the input element. The error may also be referred to as an approximation error. The approximation error may indicate a difference between output of the linear function (i.e., approximated output) and output of the activation function (i.e., real output). In an embodiment, the approximation error may be an approximation error for a single input data element, e.g., the input data element that causes the largest difference between the approximated output and the real output. In another embodiment, the approximation error may be an average error across some or all of the input data elements in the input segment. For instance, the linear approximation module 430 may compute the difference between the approximated output and the real output for each of the input elements and compute an average of the differences as the approximation error.

The linear approximation module 430 may further compare the approximation error with the target accuracy of the input segment. In embodiments where the linear approximation module 430 determines that the approximation error is within the target budget, the linear approximation module 430 may end the iterative process. In embodiments where the linear approximation module 430 determines that the approximation error is beyond the target budget, the linear approximation module 430 may divide the input segment into multiple new input segments. For instance, the linear approximation module 430 may divide the input segment into two input segments. The linear approximation module 430 may perform the iterative process on each of the new input segments separately based on the target accuracy of the input segment. In embodiments where the linear approximation module 430 determines that the approximation error of a new input segment is beyond the target budget, the linear approximation module 430 may further divide the new input segment. This process may continue till the linear approximation module 430 finds the linear functions that meet the target accuracy of the input segment.

After the linear approximation module 430 finds the linear function(s) for the input segment, the linear approximation module 430 may select another input segment (or another exponent) and use the same process to find linear function(s) for the other input segment. This continues till the linear approximation module 430 finds linear functions for all the input segments in the input range.

The LUT configuration module 440 configures the LUT with parameters of the linear functions used to approximate the activation function. In some embodiments, the LUT configuration module 440 generates a configuration descriptor that includes the parameters of all the determined linear functions. Examples of the parameters include intercepts, slopes, or other types of parameters of the linear functions. The LUT configuration module 440 may provide the configuration descriptor to the data processing unit where the parameters of the linear function are stored as entries in the LUT. In some embodiments, the parameters of the same linear function may be grouped as a single entry of the LUT.

In some embodiments, the LUT configuration module 440 may also determine a datatype for the configuration descriptor or for the LUT. In some embodiments, the LUT configuration module 440 may obtain, e.g., from the training module 320, a desired datatype of the output data elements of the activation function. The desired datatype of the output data elements of the activation function may be predetermined by the training module 320. The activation function module 350 may determine the datatype for the configuration descriptor or for the LUT based on the input range, the required output range (i.e., the range of output data elements of the activation function), the input datatype, desired output datatype, other factors, or some combination thereof. In an example where the required output range is from −65504 to 65504, the LUT configuration module 440 may select the datatype of the LUT from FP8, FP16, BF16, and FP32. In an example where the required output range is from −3.39×10³⁸ to 3.39×10³⁸, the LUT configuration module 440 may select the datatype of the LUT from BF16 and FP32. In an example where the required output range is from −3.4×10³⁸ to 3.4×10³⁸, the LUT configuration module 440 may select the datatype of the LUT from BF16 and FP32. In some embodiments, the LUT configuration module 440 may also generate additional LUT configuration parameters that may include information indicating addresses of entries in the LUT.

FIG. 5 illustrates a PPE array 500 including LUTs 520, in accordance with various embodiments. The LUTs 520 are individually referred to as “LUT 520.” The PPE array 500 also includes PPEs 510, which are individually referred to as “PPE 510.” The PPEs 510 may be on one or more compute data paths of the PPE array 500. In other embodiments, alternative configurations, different or additional components may be included in the PPE array 500. For instance, the PPE array 500 may include a different number of PPEs 510 or LUTs 520. Further, functionality attributed to a component of the PPE array 500 may be accomplished by a different component included in the PPE array 500 or a different module, device, or system. The PPE array 500 may be an example of the PPE array 260 in FIG. 2.

Each PPE 510 may receive input data and compute output data to be used as outputs of activation functions. The output data may be approximated outputs of non-linear activation functions. In some embodiments, a PPE may include one or more compute units and one or more register files. A compute unit may be configured to execute linear functions, including linear functions used to approximate non-linear activation functions. A compute unit may include one or more multipliers and one or more accumulators. A register file in a PPE 510 may be used to store data input into the PPE 510, such as input data elements of non-linear activation functions, slopes and intercepts of linear functions approximating the non-linear activation functions, and so on. The register file or a separate register file in the PPE 510 may store data computed by the PPE 510, which may be output data elements of non-linear activation function.

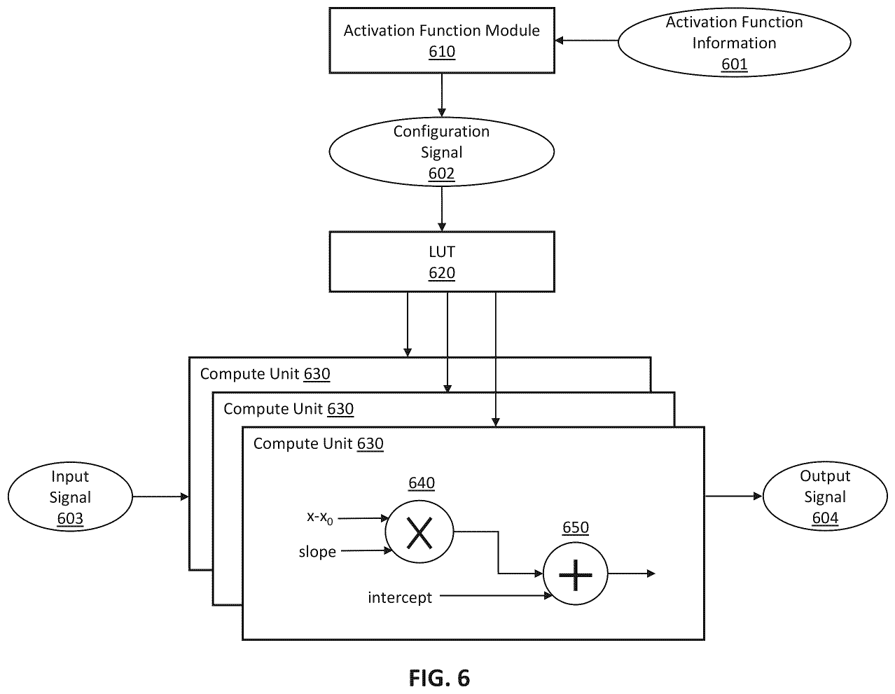

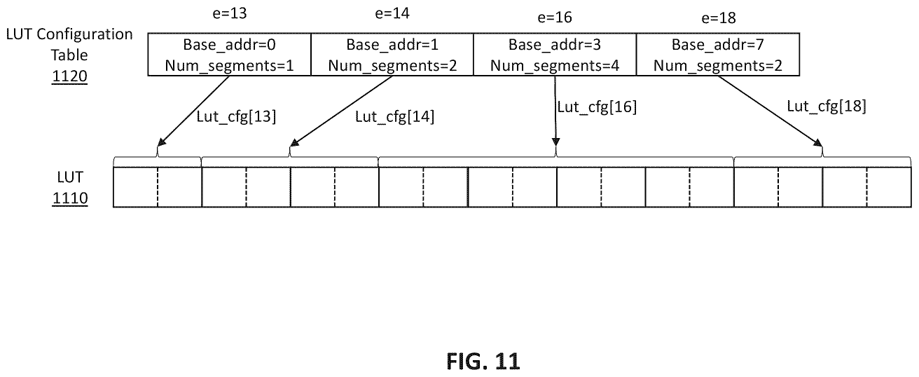

The LUTs 520 store parameters of linear functions executed by the PPEs 510. A LUT 520 may include a certain number of entries. The total number of entries in the LUT 520 may indicate the size of the LUT 520. The size of the LUT 520 may be no greater than a LUT size limit that corresponds to an area budget for the LUT 520. In some embodiments, a single LUT 520 may have an area budget. In other embodiments, some or all of the LUTs 520 in the PPE array 500 share an area budget. The LUTs 520 may be programmable. For instance, the entries of the LUTs 520 can be configured, e.g., by the activation function module 350. The entries of the LUTs 520 may be reconfigured and updated so that the LUTs 520 can be used for approximating various activation functions. The LUTs 520 may support various floating-point data types. The datatype of a LUT 520 may also be configured by the activation function module 350. In some embodiments, the LUTs 520 may have entries of different data types. Examples of the LUTs 520 include the LUT 620 in FIG. 6 and the LUT 1100 in FIG. 11. Even though a LUT 520 is coupled to eight PPEs 510 in FIG. 5, a LUT 520 may be coupled to different numbers of PPEs 510 in other embodiments.

Example Approximation of Activation Function with Linear Function

FIG. 6 illustrates an example pipeline 600 of approximating activation functions, in accordance with various embodiments. The pipeline 600 includes an activation function module 610, a LUT 620, compute units 630 (individually referred to as “compute unit 630”). The activation function module 610 may be an embodiment of the activation function module 350 in FIG. 3. The LUT 620 may be an embodiment of the LUT 520 in FIG. 5. The compute units 630 may be compute units of one or more PPEs, such as the PPEs 510 in FIG. 5. In other embodiments, the pipeline 600 may include different, fewer, or more components. For example, the pipeline 600 may include multiple LUTs 620 associated with the activation function module 610. As another example, the pipeline 600 may include a different number of compute units 630 associated with the LUT 620.

In the embodiments of FIG. 6, the activation function module 610 receives activation function information 601. The activation function information 601 includes data that the activation function module 610 may use to generate a configuration signal 602. In an example, the activation function information 601 includes information associated with the activation function, such as one or more characteristics of the activation function curve, input datatype, values of input data elements, output datatype, area budget for entries in the LUT 620 to be used to execute the activation function, other types of information associated with the activation function, or some combination thereof. The activation function module 610 may determine an input range based on the input datatype. The activation function module 610 may also partition the input range into input segments, analyze statistics of the input data elements based on the values of the input data elements, and assign accuracies to the input segments based on the result of the statistics analysis and the area budget. The activation function module 610 may further determine a datatype for entries of the LUT 620 based on the input datatype or output datatype. The activation function module 610 may also use the input segments and the one or more characteristics of the activation function curve to determine linear functions for approximating the activation function. The activation function module 610 may include the parameters (e.g., intercepts, slopes, etc.) of the linear functions in the configuration signal 602. The configuration signal 602 may also include information that associates each of the linear functions with the corresponding exponent (or corresponding input segment) in the input range. The activation function module 610 may program the LUT 620 with the configuration signal 602.

The LUT 620 receives the configuration signal 602 and is configured to store the parameters of the linear functions. The configuration signal 602 may be received through a configuration bus. In some embodiments, the parameters of a single linear function are stored as a single entry in the LUT 620. For instance, the entry may start with the intercept of the linear function, followed by the slope of the linear function. In an example, an entry may include 32 bits, the intercept has 16 bits and the slope has 16 bits. The entries may have specific addresses and can be retrieved by the compute units 630 based on the addresses. The number of entries in the LUT 620 may be subject to an area budget of the LUT 620. In some embodiments, the total number of entries in the LUT 620 may be a power of 2, such as 2, 4, 8, 16, 32, 64, 128, and so on.

The compute units 630 receive an input signal 603. In some embodiments, the compute unit 630 may receive different input signals in parallel. In other embodiments, the compute unit 630 may share the input signal 603. The input signal 603 may be received through a data port, such as a data input port. The input signal 603 may include one or more input data elements of the activation function. The compute units 630 process the input data elements in the input signal 603 to compute, using the parameters of linear functions in the LUT 620, outputs of the linear functions as approximated outputs of the activation function. In the embodiments of FIG. 6, each compute unit 630 includes a multiplier 640 and an adder 650. In other embodiments, a compute unit 630 may include different, fewer, or more components. For instance, a compute unit 630 may include multiple multipliers or multiple accumulators.

In an example operation cycle for processing an input data element in the input signal 603, the LUT entry including the intercept and slope of the linear function for the input segment including the input data element may be identified. For instance, the address of the entry may be determined based on the value (or exponent) of the input data element. The intercept and slope are retrieved from the LUT 620 based on the address. The compute unit 630 receives the intercept and slope. The compute unit 630 also receives an increment value x−x₀, which is a difference between the value of the input data element x and a segment start value x₀ of the input segment including the input data element. In some embodiments, the compute unit 630 may include a subtractor that computes the increment value using the input data element and the segment start value. The multiplier 640 may compute a product of the increment value and the slope. The adder 650 receives the product from the multiplier 640 and the intercept of the linear function. The adder 650 accumulates the product and the intercept and computes the approximated output data element of the activation function. The output of the adder 650 may be sent out from the compute unit 630 through a data port (e.g., data output port) as a data element in an output signal 604 of the activation function.

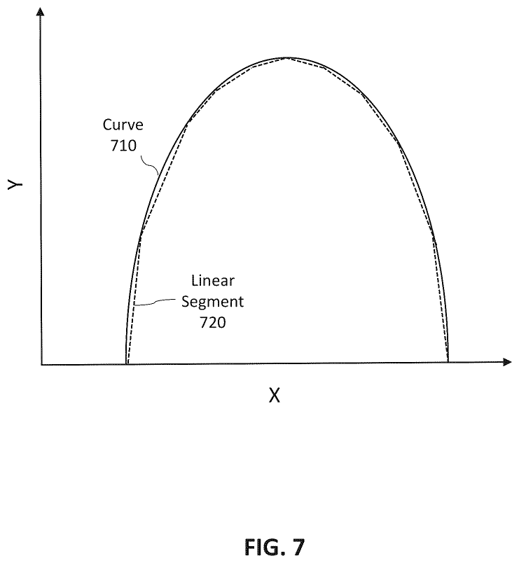

FIG. 7 illustrates an example non-linear curve 710 and linear curves 720 approximating the non-linear curve 710, in accordance with various embodiments. The non-linear curve 710 represents the non-linear activation function. As shown in FIG. 7, the non-linear curve 710 is in an x-y coordinate system, where x denotes input to the non-linear activation function and y denotes output of the non-linear activation function. The range of x coordinates of data points on the non-linear curve 710 may be the input range of the non-linear activation function. The non-linear curve 710 is approximated by the linear curves 720, individually referred to as linear curve 720. The linear curves 720 may also be referred to as linear segments. Each of the linear curves 720 approximates a different portion of the non-linear curve 710. For the purpose of illustration, FIG. 7 shows 10 linear curves 720. In other embodiments, the non-linear curve 710 may be approximated by a different number of linear curves 720. Each linear curve 720 represents a linear function that approximates the non-linear activation function for the corresponding segment of the input range.

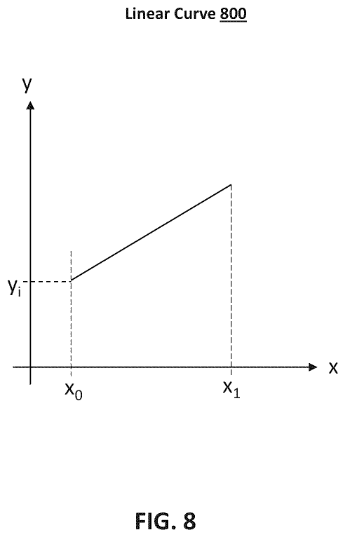

FIG. 8 illustrates an example linear curve 800, in accordance with various embodiments. The linear curve 800 may be an example of the linear curves 720 in FIG. 7. The linear curve 800 may represent a linear function that approximates a non-linear activation function for a segment in the input range of the non-linear activation function. In the embodiments of FIG. 8, the linear curve 800 corresponds to a range from x₀ to x₁. x₀ may denote the start of the linear curve 800 (e.g., the minimum input value in the linear curve 800), and x₁ may denote the end of the linear curve 800 (e.g., the maximum input value in the linear curve 800). x₀ may also be referred to as the segment start value. The linear function of the linear curve 800 may be denoted as:

y=s(x−x₀)+yᵢ,

where y denotes the output of the linear function, s denotes the slope (also referred to as “multiplier”) of the linear function, x denotes the input of the linear function, and yᵢ denotes the intercept (also referred to as “offset”) of the linear function.

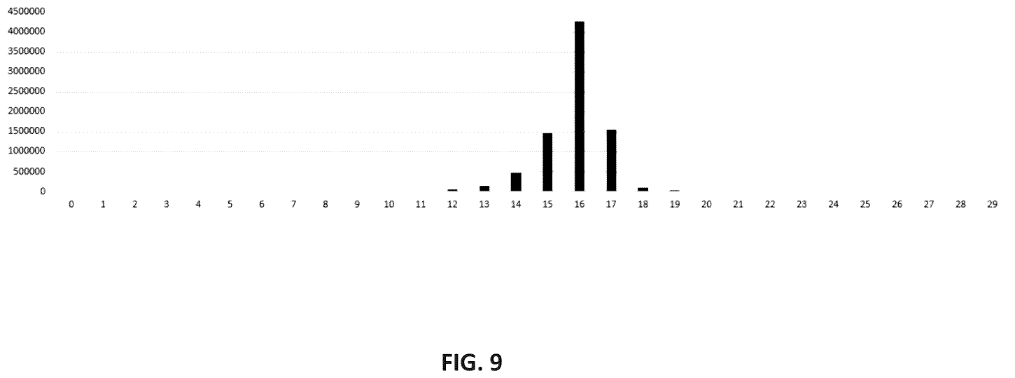

FIG. 9 is a histogram for an activation function, in accordance with various embodiments. The activation function may be a non-linear activation function. For the purpose of illustration, FIG. 9 shows 30 exponents: 0-29, which are listed along the horizontal axis of the histogram. Each of the 30 exponents corresponds to an input segment, so there may be 30 input segments in the input range. The histogram shows the distribution of input data elements in the input range with respect to the input segments. The histogram includes eight bars for eight of the 30 exponents. The height of a bar indicates the number of input data elements having the corresponding exponent, i.e., the number of input data elements falling into the corresponding input segment. For the other 22 input segments, the number of input data elements may be too small (or even zero) to be shown in the histogram. The height of the bars may be used as distribution frequencies of the input segments. As shown in FIG. 9, the input segments have different distribution frequencies. The input segment for the exponent value 16 has the highest distribution frequency, meaning the input segment has the most input data elements.

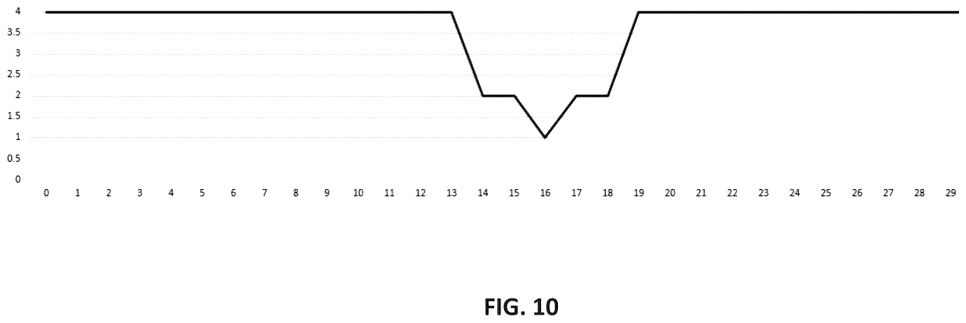

FIG. 10 is a diagram showing different accuracies determined for different exponents in an input range of the activation function in FIG. 9, in accordance with various embodiments. The horizontal axis of the diagram shows the exponents in the input range. The vertical axis of the diagram shows the ULPs assigned to the exponents. The ULPs indicate target accuracies determined for the exponents. A higher ULP indicates a lower target accuracy. The ULPs of the exponents are determined based on the distribution frequencies of the corresponding input segment. As shown in FIG. 10, the exponent value 16 has the lowest ULP, i.e., the highest target accuracy, as the input segment for the exponent value 16 has the highest distribution frequency as shown in the histogram in FIG. 9. The exponent values 0-13 and 19-29 have the highest ULP, i.e., the lowest target accuracy. The other exponents have target accuracies in between.

FIG. 11 illustrates a programmable LUT 1110, in accordance with various embodiments. The LUT 1110 may be an example of the LUTs 520 in FIG. 5 or an example of the LUT 620 in FIG. 6. FIG. 11 shows nine entries in the LUT 1110. Each entry is represented by two squares separated by a dashed line. Each entry may save parameters of a single linear function. The two squares may represent intercept and slope, respectively. The LUT 1110 may include fewer or more entries. The LUT 1110 may be programmed using a LUT configuration table 1120. For the purpose of illustration, the LUT configuration table 1120 includes four entries that have configuration parameters for four exponents (13, 14, 16, and 18), respectively. Each entry in the LUT configuration table 1120 has data representing a base address (represented by “Base_addr” in FIG. 11) and data representing the number of input segments (represented by “Num_segments” in FIG. 11) for each exponent.

An input segment may correspond to a single linear function that approximates the activation function for the input segment. The number of input segments for an exponent may equal the number of linear functions used to approximate the activation function for the exponent and equal the number of LUT entries needed for the approximation. The number of input elements may depend on the target accuracy of the corresponding exponent, which is determined based on the number of input data elements having the exponent. The entries in the LUT 1110 may be better used for exponents having more input data elements, which can facilitate improvement of the accuracy of the approximation. As indicated by the first entry of the LUT configuration table 1120, there is one input segment for exponent value 13. The first entry of the LUT configuration table 1120 configures the first entry in the LUT 1110 with configuration parameters represented by “Lut_cfg[13]” in FIG. 11. The configuration parameters may include the intercept and slope of the linear function and are written into the first entry in the LUT 1110.

Also, the second entry of the LUT configuration table 1120 indicates that there are two input segments for exponent value 14 and configures two entries in the LUT 1110 with configuration parameters represented by “Lut_cfg[14]” in FIG. 11. The configuration parameters may include the intercepts and slopes of the two linear functions for the two input segments and are respectively written into the two entries in the LUT 1110. The third entry of the LUT configuration table 1120 indicates that there are four input segments for exponent value 16 and configures four entries in the LUT 1110 with configuration parameters represented by “Lut_cfg[16]” in FIG. 11. The configuration parameters may include the intercepts and slopes of the four linear functions for the four input segments and are respectively written into the four entries in the LUT 1110. The fourth entry of the LUT configuration table 1120 indicates that there are two input segments for exponent value 18 and configures two entries in the LUT 1110 with configuration parameters represented by “Lut_cfg[18]” in FIG. 11. The configuration parameters may include the intercepts and slopes of the two linear functions for the two input segments and are respectively written into the two entries in the LUT 1110.

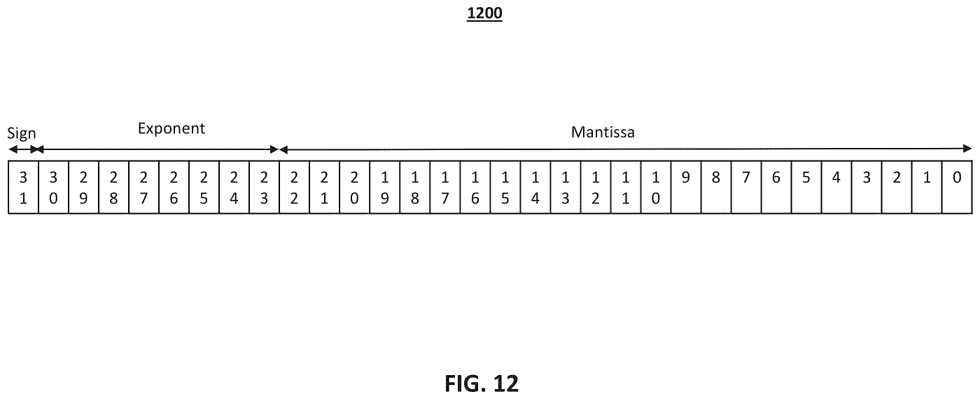

FIG. 12 illustrates an example floating-point datatype 1200, in accordance with various embodiments. The floating-point datatype 1200 is FP32. As shown in FIG. 12, a data element with the floating-point datatype 1200 may be stored as a sequence of 32 bits: 0-31. One bit is used to encode the sign of the data element. The sign may be negative or positive. Eight bits are used to encode the exponent of the data element. The other 23 bits are used to encode the mantissa of the data element. The values of exponents of data elements with the floating-point datatype 1200 may be in a range from 0 to 255. There can be a plurality of data elements having the same exponent.

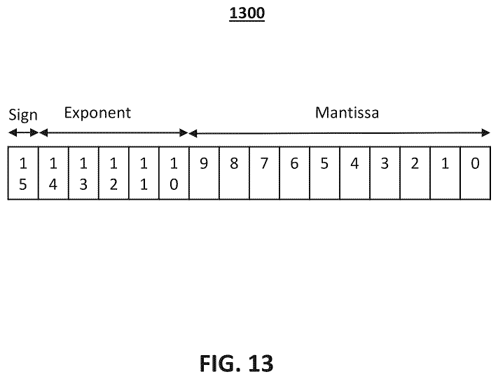

FIG. 13 illustrates another example floating-point datatype 1300, in accordance with various embodiments. The floating-point datatype 1300 is FP16. As shown in FIG. 13, a data element with the floating-point datatype 1300 may be stored as a sequence of 16 bits: 0-15. One bit is used to encode the sign of the data element. The sign may be negative or positive. Five bits are used to encode the exponent of the data element. The other 10 bits are used to encode the mantissa of the data element. The values of exponents of data elements with the floating-point datatype 1300 may be in a range from 0 to 31. There can be a plurality of data elements having the same exponent.

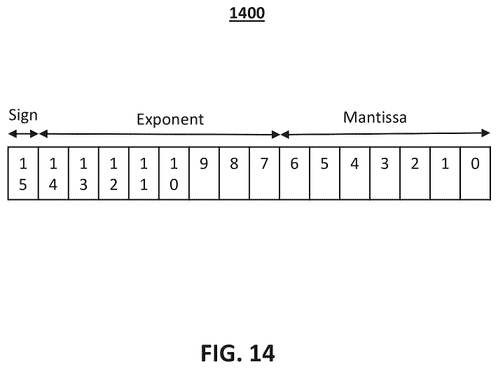

FIG. 14 illustrates yet another example floating-point datatype 1400, in accordance with various embodiments. The floating-point datatype 1400 is BF16. As shown in FIG. 14, a data element with the floating-point datatype 1400 may be stored as a sequence of 16 bits: 0-15. One bit is used to encode the sign of the data element. The sign may be negative or positive. Eight bits are used to encode the exponent of the data element. The other seven bits are used to encode the mantissa of the data element. The values of exponents of data elements with the floating-point datatype 1400 may be in a range from 0 to 255. There can be a plurality of data elements having the same exponent.

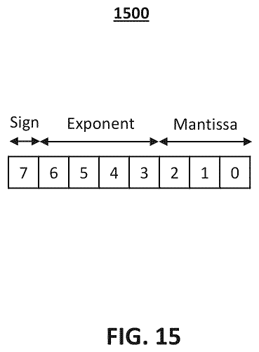

FIG. 15 illustrates yet another example floating-point datatype, in accordance with various embodiments. The floating-point datatype 1500 is FP8. As shown in FIG. 15, a data element with the floating-point datatype 1500 may be stored as a sequence of 8 bits: 0-7. One bit is used to encode the sign of the data element. The sign may be negative or positive. Four bits are used to encode the exponent of the data element. The other three bits are used to encode the mantissa of the data element. The values of exponents of data elements with the floating-point datatype 1500 may be in a range from 0 to 15. There can be a plurality of data elements having the same exponent.

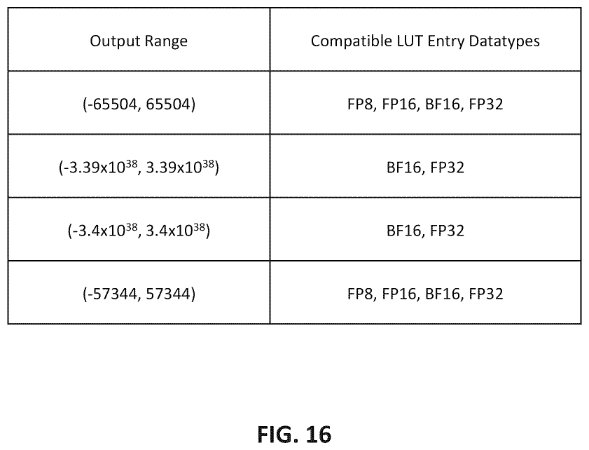

FIG. 16 illustrates compatible datatypes of LUT entries for various output ranges of activation functions, in accordance with various embodiments. An output range is the range of output data elements of an activation function. FIG. 16 shows four output ranges. The first output range is from −65504 to 65504. The second output range is from −3.39×10³⁸ to 3.39×10³⁸. The third output range is from −3.40×10³⁸ to 3.40×10³⁸. The fourth output range is from −57344 to 57344. These four output ranges are examples. There can be other output ranges for activation functions.

The compatible LUT entry datatypes for the first output range include FP8, FP16, BF16, and FP32. The compatible LUT entry datatypes for the second output range include BF16 and FP32. The compatible LUT entry datatypes for the third output range include BF16 and FP32. The compatible LUT entry datatypes for the fourth output range include FP8, FP16, BF16, and FP32. The datatypes shown in FIG. 16 are examples. Other datatypes may be used for LUT entries to support other output ranges.

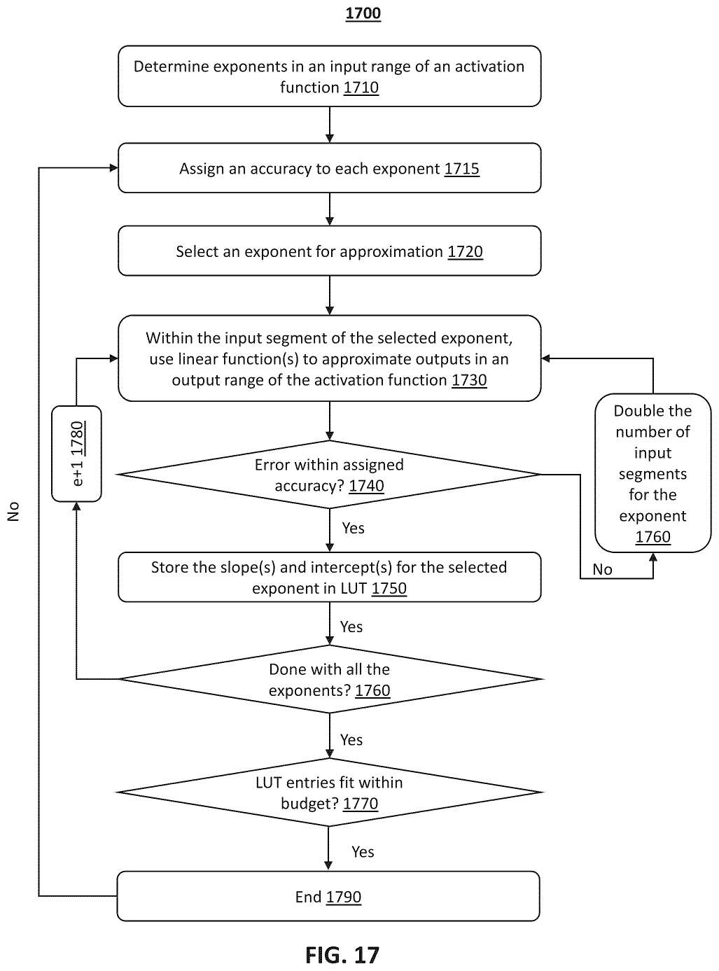

FIG. 17 is a flowchart showing a process 1700 of executing a non-linear activation function in a DNN, in accordance with various embodiments. Although the process 1700 is described with reference to the flowchart illustrated in FIG. 17, many other processes for executing activation functions in DNNs may alternatively be used. For example, the order of execution of the steps in FIG. 17 may be changed. As another example, some of the steps may be changed, eliminated, or combined.

In Step 1710, exponents in an input range of an activation function are determined. The exponents may be determined based on the datatype of input data elements of the activation function. For instance, the datatype may indicate the number of bits used to represent exponent. The exponents may be determined based on the number of bits. An exponent may correspond to a segment of the input range, i.e., an input segment.

In Step 1715, an accuracy is assigned to each exponent. The accuracy may be range specific or exponent specific. Different exponents determined in Step 1710 may be assigned with different accuracies. A higher accuracy may be assigned to an exponent that more input data elements have. In some embodiments, the accuracy is represented by a ULP.

In Step 1720, an exponent is selected for approximation. The exponent may be selected from the exponents determined in Step 1710. In some embodiments, the selected exponent corresponds to an input segment that includes at least one input data element of the activation function.

In Step 1730, one or more linear functions are used within the input segment of the selected exponent to approximate outputs in an output range of the activation function. A linear function may have an intercept and a slope.

In Step 1740, it is determined whether an error of the approximated outputs is within the assigned accuracy. The error may be a difference between the approximated outputs and real outputs of the non-linear activation function.

In embodiments where the error is within the assigned accuracy, Step 1750 is performed, in which the slope and intercept of the linear segment are stored in a LUT. Examples of the LUT include the LUTs 520 in FIG. 5, the LUT 620 in FIG. 6, and the LUT 1110 in FIG. 11. The slope and intercept of a linear function may be stored together as a single entry in the LUT.

In embodiments where the error is not within the assigned accuracy, Step 1760 is performed, in which the number of input segments for the exponent is doubled. For instance, a previous input segment of the exponent is partitioned into two new input segments corresponding to two different linear functions. In other embodiments, a previous input segment may be partitioned into more than two new input segments. For each of the new input segments, Step 1730 is performed. Subsequent steps may be performed too till the slope and intercept of one or more linear functions meeting the assigned accuracy of the exponent are stored in the LUT in Step 1750.

In Step 1760, it is determined whether all the exponents are done. For instance, it may be determined whether the parameters of linear functions for all the exponents have been stored in the LUT.

In embodiments where all the exponents are done, Step 1770 is performed, in which it is determined whether LUT entries fit within budget. For instance, it may be determined whether the area required by the LUT entries for storing the parameters of the linear functions for all the exponents is within the area budget. In embodiments where not all the exponents are done, Step 1780 is performed, where the value of the exponent is increased by one to select the next exponent. Step 1730 is performed. Subsequent steps may be performed too till the slope and intercept of one or more linear functions meeting the assigned accuracy of the next exponent are stored in the LUT in Step 1750.

In embodiments where the LUT entries fit within the budget, Step 1790 is performed and the process 1700 is ended. In embodiments where the LUT entries do not fit within the budget, Step 1715 is re-performed for the exponent. For instance, the previously assigned accuracy may be reduced in Step 1715. Subsequent steps may be performed too till the slope and intercept of one or more linear functions meeting the newly assigned accuracy of the exponent are stored in the LUT in Step 1750.

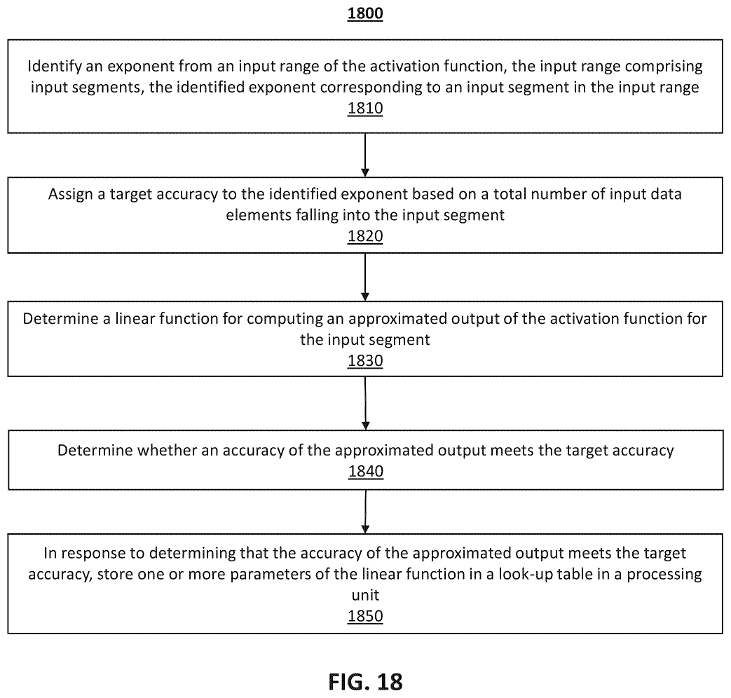

FIG. 18 is a flowchart showing a method 1800 of approximating a non-linear activation function in a DNN, in accordance with various embodiments. The method 1800 may be performed by the activation function module 350 in FIGS. 3 and 4. Although the method 1800 is described with reference to the flowchart illustrated in FIG. 18, many other methods for approximating activation functions may alternatively be used. For example, the order of execution of the steps in FIG. 18 may be changed. As another example, some of the steps may be changed, eliminated, or combined.

The activation function module 350 identifies 1810 an exponent from an input range of the activation function. The input range comprises input segments. The identified exponent corresponds to an input segment in the input range. In some embodiments, the input range is a range of input data elements of the activation function,

The activation function module 350 assigns 1820 a target accuracy to the identified exponent based on a total number of input data elements falling into the input segment. In some embodiments, the activation function module 350 determines a ratio of the number of input data elements falling into the input segment to a total number of input data elements in the input range. The activation function module 350 assigns the target accuracy based on the determined ratio. In some embodiments, the activation function module 350 determines a ULP based on a spacing between two consecutive floating-point numbers in the input segment. The accuracy is represented by the ULP.

In some embodiments, the activation function module 350 assigns a different target accuracy to a different exponent in the input range. The different target accuracy is higher than the target accuracy. A number of input data elements falling into a different input segment corresponding to the different exponent is greater than the number of input data elements falling into the input segment.

The activation function module 350 determines 1830 a linear function for computing an approximated output of the activation function for the input segment. In some embodiments, the input data elements have a first floating-point datatype. The approximated output has a second floating-point datatype. The second floating-point datatype has a higher precision than the first floating-point datatype.

The activation function module 350 determines 1840 whether an accuracy of the approximated output meets the target accuracy. In some embodiments, the activation function module 350 determines different linear functions for computing approximate outputs of the activation function for a different input segment. The activation function module 350 stores parameters of the different linear functions in two or more entries of the LUT. The one or more parameters of the linear function are stored in one entry of the LUT.

The activation function module 350 stores 1850 one or more parameters of the linear function in a LUT in a processing unit in response to determining that the accuracy of the approximated output meets the target accuracy. In some embodiments, the LUT is to be used by one or more compute units in the processing unit to execute the activation function.

In some embodiments, in response to determining that the accuracy of the approximated output fails to meet the target accuracy, the activation function module 350 determines different linear functions for computing different approximated outputs of the activation function for the input segment. A different linear function corresponds to a portion of the input segment. After determining that an accuracy of the different approximated outputs meets the target accuracy, the activation function module 350 stores parameters of the different linear functions in the LUT. In some embodiments, the activation function module 350 stores the parameters of the different linear functions in a plurality of entries in the LUT. An entry corresponds to one of the different linear functions.

In some embodiments, the target accuracy is assigned further based on a size of an area in the processing unit that is available for the LUT. The activation function module 350 stores parameters of linear functions for computing one or more approximated outputs of the activation function for one or more other input segments of the input range into the LUT. After storing the parameters, the activation function module 350 determines whether a size of the LUT exceeds the area in the processing unit. In response to determining that the size of the LUT exceeds the area in the processing unit, the activation function module 350 modifies the accuracy assigned to the identified exponent.

Example Computing Device

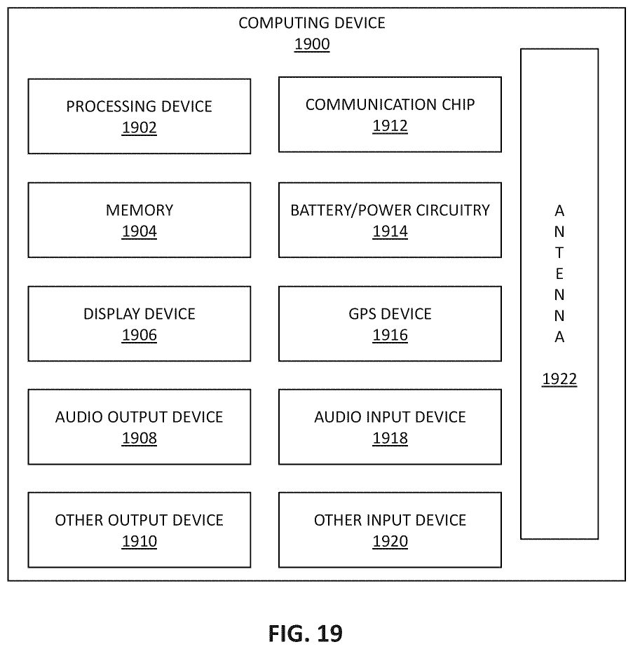

FIG. 19 is a block diagram of an example computing device 1900, in accordance with various embodiments. In some embodiments, the computing device 1900 can be used as at least part of the DNN system 190, such as the DNN module 191 in the DNN system 190. A number of components are illustrated in FIG. 19 as included in the computing device 1900, but any one or more of these components may be omitted or duplicated, as suitable for the application. In some embodiments, some or all of the components included in the computing device 1900 may be attached to one or more motherboards. In some embodiments, some or all of these components are fabricated onto a single system on a chip (SoC) die. Additionally, in various embodiments, the computing device 1900 may not include one or more of the components illustrated in FIG. 19, but the computing device 1900 may include interface circuitry for coupling to the one or more components. For example, the computing device 1900 may not include a display device 1906, but may include display device interface circuitry (e.g., a connector and driver circuitry) to which a display device 1906 may be coupled. In another set of examples, the computing device 1900 may not include an audio input device 1918 or an audio output device 1908, but may include audio input or output device interface circuitry (e.g., connectors and supporting circuitry) to which an audio input device 1918 or audio output device 1908 may be coupled.

The computing device 1900 may include a processing device 1902 (e.g., one or more processing devices). The processing device 1902 processes electronic data from registers and/or memory to transform that electronic data into other electronic data that may be stored in registers and/or memory. The computing device 1900 may include a memory 1904, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1904 may include memory that shares a die with the processing device 1902. In some embodiments, the memory 1904 includes one or more non-transitory computer-readable media storing instructions executable to perform operations for executing activation functions in DNNs, e.g., the process 1700 described above in conjunction with FIG. 17, the method 1800 described above in conjunction with FIG. 18, or some operations performed by the DNN system 200 (e.g., the DNN module 201 or the PPE array 260) described above in conjunction with FIG. 2. The instructions stored in the one or more non-transitory computer-readable media may be executed by the processing device 1902.

In some embodiments, the computing device 1900 may include a communication chip 1912 (e.g., one or more communication chips). For example, the communication chip 1912 may be configured for managing wireless communications for the transfer of data to and from the computing device 1900. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1912 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1912 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1912 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1912 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1912 may operate in accordance with other wireless protocols in other embodiments. The computing device 1900 may include an antenna 1922 to facilitate wireless communications and/or to receive other wireless communications (such as AM or FM radio transmissions).

In some embodiments, the communication chip 1912 may manage wired communications, such as electrical, optical, or any other suitable communication protocols (e.g., the Ethernet). As noted above, the communication chip 1912 may include multiple communication chips. For instance, a first communication chip 1912 may be dedicated to shorter-range wireless communications such as Wi-Fi or Bluetooth, and a second communication chip 1912 may be dedicated to longer-range wireless communications such as global positioning system (GPS), EDGE, GPRS, CDMA, WiMAX, LTE, EV-DO, or others. In some embodiments, a first communication chip 1912 may be dedicated to wireless communications, and a second communication chip 1912 may be dedicated to wired communications.

The computing device 1900 may include battery/power circuitry 1914. The battery/power circuitry 1914 may include one or more energy storage devices (e.g., batteries or capacitors) and/or circuitry for coupling components of the computing device 1900 to an energy source separate from the computing device 1900 (e.g., AC line power).

The computing device 1900 may include a display device 1906 (or corresponding interface circuitry, as discussed above). The display device 1906 may include any visual indicators, such as a heads-up display, a computer monitor, a projector, a touchscreen display, a liquid crystal display (LCD), a light-emitting diode display, or a flat panel display, for example.

The computing device 1900 may include an audio output device 1908 (or corresponding interface circuitry, as discussed above). The audio output device 1908 may include any device that generates an audible indicator, such as speakers, headsets, or earbuds, for example.

The computing device 1900 may include an audio input device 1918 (or corresponding interface circuitry, as discussed above). The audio input device 1918 may include any device that generates a signal representative of a sound, such as microphones, microphone arrays, or digital instruments (e.g., instruments having a musical instrument digital interface (MIDI) output).

The computing device 1900 may include a GPS device 1916 (or corresponding interface circuitry, as discussed above). The GPS device 1916 may be in communication with a satellite-based system and may receive a location of the computing device 1900, as known in the art.

The computing device 1900 may include another output device 1910 (or corresponding interface circuitry, as discussed above). Examples of the other output device 1910 may include an audio codec, a video codec, a printer, a wired or wireless transmitter for providing information to other devices, or an additional storage device.

The computing device 1900 may include another input device 1920 (or corresponding interface circuitry, as discussed above). Examples of the other input device 1920 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1900 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1900 may be any other electronic device that processes data.

### SELECT EXAMPLES

The following paragraphs provide various examples of the embodiments disclosed herein.
Example 1 provides a method for approximating an activation function in a neural network, the method including identifying an exponent from an input range of the activation function, the input range including one or more input segments, the identified exponent corresponding to an input segment in the input range; assigning a target accuracy to the identified exponent based on a total number of input data elements falling into the input segment; determining a linear function for computing an approximated output of the activation function for the input segment; determining whether an accuracy of the approximated output meets the target accuracy; and in response to determining that the accuracy of the approximated output meets the target accuracy, storing one or more parameters of the linear function in a LUT in a processing unit.
Example 2 provides the method of example 1, further including in response to determining that the accuracy of the approximated output fails to meet the target accuracy: determining different linear functions for computing different approximated outputs of the activation function for the input segment, a different linear function corresponding to a portion of the input segment, and after determining that an accuracy of the different approximated outputs meets the target accuracy, storing parameters of the different linear functions in the LUT.
Example 3 provides the method of example 2, in which storing the parameters of the different linear functions in the LUT includes storing the parameters of the different linear functions in a plurality of entries in the LUT, an entry corresponding to one of the different linear functions.
Example 4 provides the method of any one of examples 1-3, in which assigning the target accuracy to the identified exponent includes determining a ratio of the number of input data elements falling into the input segment to a total number of input data elements in the input range; and assigning the target accuracy based on the determined ratio.
Example 5 provides the method of any one of examples 1-4, further including assigning a different target accuracy to a different exponent in the input range, in which the different target accuracy is higher than the target accuracy, and a number of input data elements falling into a different input segment corresponding to the different exponent is greater than the number of input data elements falling into the input segment.
Example 6 provides the method of example 5, further including determining different linear functions for computing approximate outputs of the activation function for the different input segment; and storing parameters of the different linear functions in two or more entries of the LUT, in which the one or more parameters of the linear function are stored in one entry of the LUT.
Example 7 provides the method of any one of examples 1-6, in which the target accuracy is assigned further based on a size of an area in the processing unit that is available for the LUT.
Example 8 provides the method of example 7, further including storing parameters of linear functions for computing one or more approximated outputs of the activation function for one or more other input segments of the input range into the LUT; and after storing the parameters, determining whether a size of the LUT exceeds the area in the processing unit; and in response to determining that the size of the LUT exceeds the area in the processing unit, modifying the accuracy assigned to the identified exponent.
Example 9 provides the method of any one of examples 1-8, in which the input data elements have a first floating-point datatype, and the approximated output has a second floating-point datatype, and the second floating-point datatype has a higher precision than the first floating-point datatype.
Example 10 provides the method of any one of examples 1-9, in which assigning the target accuracy to the exponent includes determining a ULP based on a spacing between two consecutive floating-point numbers in the input segment, in which the accuracy is represented by the ULP.
Example 11 provides one or more non-transitory computer-readable media storing instructions executable to perform operations for approximating an activation function in a neural network, the method including identifying an exponent from an input range of the activation function, the input range including one or more input segments, the identified exponent corresponding to an input segment in the input range; assigning a target accuracy to the identified exponent based on a total number of input data elements falling into the input segment; determining a linear function for computing an approximated output of the activation function for the input segment; determining whether an accuracy of the approximated output meets the target accuracy; and in response to determining that the accuracy of the approximated output meets the target accuracy, storing one or more parameters of the linear function in a LUT in a processing unit.
Example 12 provides the one or more non-transitory computer-readable media of example 11, in which the operations further include in response to determining that the accuracy of the approximated output fails to meet the target accuracy: determining different linear functions for computing different approximated outputs of the activation function for the input segment, a different linear function corresponding to a portion of the input segment, and after determining that an accuracy of the different approximated outputs meets the target accuracy, storing parameters of the different linear functions in the LUT.
Example 13 provides the one or more non-transitory computer-readable media of example 12, in which storing the parameters of the different linear functions in the LUT includes storing the parameters of the different linear functions in a plurality of entries in the LUT, an entry corresponding to one of the different linear functions.
Example 14 provides the one or more non-transitory computer-readable media of any one of examples 11-13, in which assigning the target accuracy to the identified exponent includes determining a ratio of the number of input data elements falling into the input segment to a total number of input data elements in the input range; and assigning the target accuracy based on the determined ratio.
Example 15 provides the one or more non-transitory computer-readable media of any one of examples 11-14, in which the operations further include assigning a different target accuracy to a different exponent in the input range, in which the different target accuracy is higher than the target accuracy, and a number of input data elements falling into a different input segment corresponding to the different exponent is greater than the number of input data elements falling into the input segment.
Example 16 provides the one or more non-transitory computer-readable media of any one of examples 11-15, in which the target accuracy is assigned further based on a size of an area in the processing unit that is available for the LUT.
Example 17 provides the one or more non-transitory computer-readable media of any one of examples 11-16, in which the input data elements have a first floating-point datatype, and the approximated output has a second floating-point datatype, and the second floating-point datatype has a higher precision than the first floating-point datatype.
Example 18 provides an apparatus, including a computer processor for executing computer program instructions; and a non-transitory computer-readable memory storing computer program instructions executable by the computer processor to perform operations including identifying an exponent from an input range of the activation function, the input range including one or more input segments, the identified exponent corresponding to an input segment in the input range, assigning a target accuracy to the identified exponent based on a total number of input data elements falling into the input segment, determining a linear function for computing an approximated output of the activation function for the input segment, determining whether an accuracy of the approximated output meets the target accuracy, and in response to determining that the accuracy of the approximated output meets the target accuracy, storing one or more parameters of the linear function in a LUT in a processing unit.
Example 19 provides the apparatus of example 18, in which the operations further include assigning a different target accuracy to a different exponent in the input range, in which the different target accuracy is higher than the target accuracy, and a number of input data elements falling into a different input segment corresponding to the different exponent is greater than the number of input data elements falling into the input segment.
Example 20 provides the apparatus of example 18 or 19, in which the target accuracy is assigned further based on a size of an area in the processing unit that is available for the LUT, and the operations further include storing parameters of linear functions for computing one or more approximated outputs of the activation function for one or more other input segments of the input range into the LUT; and after storing the parameters, determining whether a size of the LUT exceeds the area in the processing unit; and in response to determining that the size of the LUT exceeds the area in the processing unit, modifying the accuracy assigned to the identified exponent.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method for approximating an activation function in a neural network, the method comprising:
identifying an exponent from an input range of the activation function, the input range comprising one or more input segments, the identified exponent corresponding to an input segment in the input range;
assigning a target accuracy to the identified exponent based on a total number of input data elements falling into the input segment;
determining a linear function for computing an approximated output of the activation function for the input segment;
determining whether an accuracy of the approximated output meets the target accuracy; and
in response to determining that the accuracy of the approximated output meets the target accuracy, storing one or more parameters of the linear function in a look-up table in a processing unit.

2. The method of claim 1, further comprising:
in response to determining that the accuracy of the approximated output fails to meet the target accuracy:
determining different linear functions for computing different approximated outputs of the activation function for the input segment, a different linear function corresponding to a portion of the input segment, and
after determining that an accuracy of the different approximated outputs meets the target accuracy, storing parameters of the different linear functions in the look-up table.

3. The method of claim 2, wherein storing the parameters of the different linear functions in the look-up table comprises:
storing the parameters of the different linear functions in a plurality of entries in the look-up table, an entry corresponding to one of the different linear functions.

4. The method of claim 1, wherein assigning the target accuracy to the identified exponent comprises:
determining a ratio of the number of input data elements falling into the input segment to a total number of input data elements in the input range; and
assigning the target accuracy based on the determined ratio.

5. The method of claim 1, further comprising:
assigning a different target accuracy to a different exponent in the input range,
wherein the different target accuracy is higher than the target accuracy, and a number of input data elements falling into a different input segment corresponding to the different exponent is greater than the number of input data elements falling into the input segment.

6. The method of claim 5, further comprising:
determining different linear functions for computing approximate outputs of the activation function for the different input segment; and
storing parameters of the different linear functions in two or more entries of the look-up table,
wherein the one or more parameters of the linear function are stored in one entry of the look-up table.

7. The method of claim 1, wherein the target accuracy is assigned further based on a size of an area in the processing unit that is available for the look-up table.

8. The method of claim 7, further comprising:
storing parameters of linear functions for computing one or more approximated outputs of the activation function for one or more other input segments of the input range into the look-up table; and
after storing the parameters, determining whether a size of the look-up table exceeds the area in the processing unit; and
in response to determining that the size of the look-up table exceeds the area in the processing unit, modifying the accuracy assigned to the identified exponent.

9. The method of claim 1, wherein the input data elements have a first floating-point datatype, and the approximated output has a second floating-point datatype, and the second floating-point datatype has a higher precision than the first floating-point datatype.

10. The method of claim 1, wherein assigning the target accuracy to the exponent comprises:
determining a unit of least precision based on a spacing between two consecutive floating-point numbers in the input segment, wherein the accuracy is represented by the unit of least precision.

11. One or more non-transitory computer-readable media storing instructions executable to perform operations for approximating an activation function in a neural network, the operations comprising:
identifying an exponent from an input range of the activation function, the input range comprising one or more input segments, the identified exponent corresponding to an input segment in the input range;
assigning a target accuracy to the identified exponent based on a total number of input data elements falling into the input segment;
determining a linear function for computing an approximated output of the activation function for the input segment;
determining whether an accuracy of the approximated output meets the target accuracy; and
in response to determining that the accuracy of the approximated output meets the target accuracy, storing one or more parameters of the linear function in a look-up table in a processing unit.

12. The one or more non-transitory computer-readable media of claim 11, wherein the operations further comprise:
in response to determining that the accuracy of the approximated output fails to meet the target accuracy:
determining different linear functions for computing different approximated outputs of the activation function for the input segment, a different linear function corresponding to a portion of the input segment, and
after determining that an accuracy of the different approximated outputs meets the target accuracy, storing parameters of the different linear functions in the look-up table.

13. The one or more non-transitory computer-readable media of claim 12, wherein storing the parameters of the different linear functions in the look-up table comprises:
storing the parameters of the different linear functions in a plurality of entries in the look-up table, an entry corresponding to one of the different linear functions.

14. The one or more non-transitory computer-readable media of claim 11, wherein assigning the target accuracy to the identified exponent comprises:
determining a ratio of the number of input data elements falling into the input segment to a total number of input data elements in the input range; and
assigning the target accuracy based on the determined ratio.

15. The one or more non-transitory computer-readable media of claim 11, wherein the operations further comprise:
assigning a different target accuracy to a different exponent in the input range,
wherein the different target accuracy is higher than the target accuracy, and a number of input data elements falling into a different input segment corresponding to the different exponent is greater than the number of input data elements falling into the input segment.

16. The one or more non-transitory computer-readable media of claim 11, wherein the target accuracy is assigned further based on a size of an area in the processing unit that is available for the look-up table.

17. The one or more non-transitory computer-readable media of claim 11, wherein the input data elements have a first floating-point datatype, and the approximated output has a second floating-point datatype, and the second floating-point datatype has a higher precision than the first floating-point datatype.

18. An apparatus for approximating an activation function in a neural network, the apparatus comprising:
a computer processor for executing computer program instructions; and
a non-transitory computer-readable memory storing computer program instructions executable by the computer processor to perform operations comprising:
identifying an exponent from an input range of the activation function, the input range comprising one or more input segments, the identified exponent corresponding to an input segment in the input range,
assigning a target accuracy to the identified exponent based on a total number of input data elements falling into the input segment,
determining a linear function for computing an approximated output of the activation function for the input segment,
determining whether an accuracy of the approximated output meets the target accuracy, and
in response to determining that the accuracy of the approximated output meets the target accuracy, storing one or more parameters of the linear function in a look-up table in a processing unit.

19. The apparatus of claim 18, wherein the operations further comprise:
assigning a different target accuracy to a different exponent in the input range,
wherein the different target accuracy is higher than the target accuracy, and a number of input data elements falling into a different input segment corresponding to the different exponent is greater than the number of input data elements falling into the input segment.

20. The apparatus of claim 18, wherein the target accuracy is assigned further based on a size of an area in the processing unit that is available for the look-up table, and the operations further comprise:
storing parameters of linear functions for computing one or more approximated outputs of the activation function for one or more other input segments of the input range into the look-up table; and
after storing the parameters, determining whether a size of the look-up table exceeds the area in the processing unit; and
in response to determining that the size of the look-up table exceeds the area in the processing unit, modifying the accuracy assigned to the identified exponent.
